(19) United States
(12) Patent Application Publication
(10) Pub. No.: US 2026/0079328 A1
(43) Pub. Date: Mar. 19, 2026

(54) IMAGING LENS ASSEMBLY, CAMERA MODULE, AND IMAGING DEVICE

(71) Applicant: GUANGDONG OPPO MOBILE TELECOMMUNICATIONS CORP., LTD., Dongguan (CN)

(72) Inventor: Tatsuya NAKATSUJI, Nishi-ku (JP)

(21) Appl. No.: 19/402,617

(22) Filed: Nov. 26, 2025

Related U.S. Application Data
(63) Continuation of application No. PCT/CN2023/132748, filed on Nov. 20, 2023.

(51) Int. Cl. G02B 13/00; G02B 27/00; G03B 5/02; H04N 23/55; H04N 23/68

(52) U.S. Cl. CPC G02B 13/0065; G02B 13/0045; G02B 27/0018; G03B 5/02; H04N 23/55; H04N 23/687; G03B 2205/0015; G03B 2205/0023; G03B 2205/003

(57) ABSTRACT

An imaging lens assembly includes: an optical axis direction changing element that changes an optical axis direction, the optical axis direction changing element includes an incident surface disposed on a first optical axis having a first optical axis direction before being changed and an emitting surface disposed on a second optical axis having a second optical axis direction after being changed; and a lens group disposed on the second optical axis on an image side of the optical axis direction changing element and including at least one lens, the imaging lens assembly is configured such that: P_in_L<P_in_R, where P_in_L is a distance from the first optical axis to one end of the incident surface on an opposite side of the lens group, and P_in_R is a distance from the first optical axis to another end of the incident surface on the lens group side.

### CROSS REFERENCE TO RELATED APPLICATIONS

The present application is a continuation of International Patent Application No. PCT/CN2023/132748, filed Nov. 20, 2023, the entire disclosure of which is incorporated herein by reference.

### FIELD

The present disclosure relates to an imaging lens assembly, a camera module, and an imaging device, and specifically relates to the imaging lens assembly, the camera module, and the imaging device that are small and enable favorable optical performance.

### BACKGROUND

Conventionally, portable imaging devices such as mobile phones and digital cameras are widely used. As recent imaging devices are miniaturized, imaging lens assemblies mounted on the imaging devices are also required to be small. To fulfill such miniaturization requirements, conventional telescope lens assemblies secured the focal lengths within limited space by disposing a prism, which captures light from the object side, on the object side of a lens group. Such imaging lens assemblies are called as periscope-type imaging lens assemblies.

To reduce a thickness of the imaging device, a light-shielding mask, which shields light other than a central ray imaged on a center of an image sensor, was disposed on the prism of the periscope-type imaging lens assembly.

However, there is room for improvement in suppressing an increase in an F number and reducing a cost in the conventional periscope-type imaging lens assemblies.

### SUMMARY

The present disclosure provides an imaging lens, a camera module and an imaging device.

According to the present disclosure, an imaging lens assembly includes an optical axis direction changing element and a lens group.

The optical axis direction changing element that changes an optical axis direction, the optical axis direction changing element includes an incident surface disposed on a first optical axis having a first optical axis direction before being changed and an emitting surface disposed on a second optical axis having a second optical axis direction after being changed.

The lens group disposed on the second optical axis on an image side of the optical axis direction changing element and including at least one lens.

The imaging lens assembly is configured such that: P_in_L<P_in_R, where P_in_L is a distance from the first optical axis to one end of the incident surface on an opposite side of the lens group, and P_in_R is a distance from the first optical axis to another end of the incident surface on the lens group side.

### BRIEF DESCRIPTION OF THE DRAWINGS

These and/or other aspects and advantages of embodiments of the present disclosure will become apparent and more readily appreciated from the following descriptions made with reference to the drawings.

FIG. 1A is a diagram illustrating an example of a camera module according to the present disclosure.

FIG. 1B is an explanation diagram illustrating a ghost that occurs in a conventional camera module.

FIG. 2A is a diagram illustrating a second aperture of a second light-shielding mask in the camera module according to the present disclosure.

FIG. 2B is a diagram illustrating the second aperture of the second light-shielding mask in the conventional camera module.

FIG. 3 is a diagram illustrating a modification of the second aperture in the camera module according to the present disclosure.

FIG. 4 is a diagram illustrating a shielding of a ghost ray in an example of the camera module according to the present disclosure.

FIG. 5A is a diagram illustrating an example of an imaging device according to the present disclosure.

FIG. 5B is a diagram illustrating an example of the imaging device according to the present disclosure.

FIG. 5C is a diagram illustrating an example of the imaging device according to the present disclosure.

FIG. 6A is a diagram illustrating an example of the imaging device according to the present disclosure.

FIG. 6B is a diagram illustrating an example of the imaging device according to the present disclosure.

FIG. 7 is a configuration diagram of the camera module according to the first example of the present disclosure.

FIG. 8 is a diagram illustrating the shielding of the ghost ray in the camera module according to the first example of the present disclosure.

FIG. 9 is a diagram illustrating the shielding of the ghost ray in the camera module according to a first comparison example of the present disclosure.

FIG. 10 is an aberration diagram of the camera module according to the first example of the present disclosure.

FIG. 11 is a configuration diagram of the camera module according to a second example of the present disclosure.

FIG. 12 is a diagram illustrating the shielding of the ghost ray in the camera module according to the second example of the present disclosure.

FIG. 13 is a diagram illustrating the shielding of the ghost ray in the camera module according to a second comparison example of the present disclosure.

FIG. 14 is an aberration diagram of the camera module in a first position according to the second example of the present disclosure.

FIG. 15 is an aberration diagram of the camera module in a second position according to the second example of the present disclosure.

FIG. 16 is a configuration diagram of the camera module according to a third example of the present disclosure.

FIG. 17 is a diagram illustrating the shielding of the ghost ray in the camera module according to the third example of the present disclosure.

FIG. 18 is a diagram illustrating the shielding of the ghost ray in the camera module according to a third comparison example of the present disclosure.

FIG. 19 is an aberration diagram of the camera module in the first position according to the third example of the present disclosure.

FIG. 20 is an aberration diagram of the camera module in the second position according to the third example of the present disclosure.

FIG. 21 is a configuration diagram of the camera module according to a fourth example of the present disclosure.

FIG. 22 is a diagram illustrating the shielding of the ghost ray in the camera module according to the fourth example of the present disclosure.

FIG. 23 is a diagram illustrating the shielding of the ghost ray in the camera module according to a fourth comparison example of the present disclosure.

FIG. 24 is an aberration diagram of the camera module in the first position according to the fourth example of the present disclosure.

FIG. 25 is an aberration diagram of the camera module in the second position according to the fourth example of the present disclosure.

### DETAILED DESCRIPTION

Embodiments of the present disclosure will be described in detail and examples of the embodiments will be illustrated in the accompanying drawings. The same or similar elements and the elements having same or similar functions are denoted by like reference numerals throughout the descriptions. The embodiments described herein with reference to the drawings are explanatory, which aim to illustrate the present disclosure, but shall not be construed to limit the present disclosure.

### <Outline of the Present Disclosure>

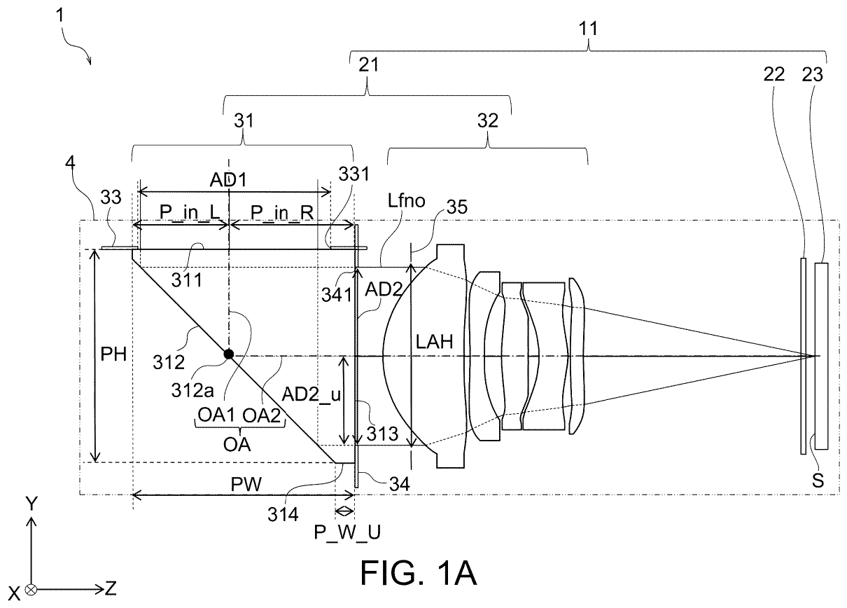

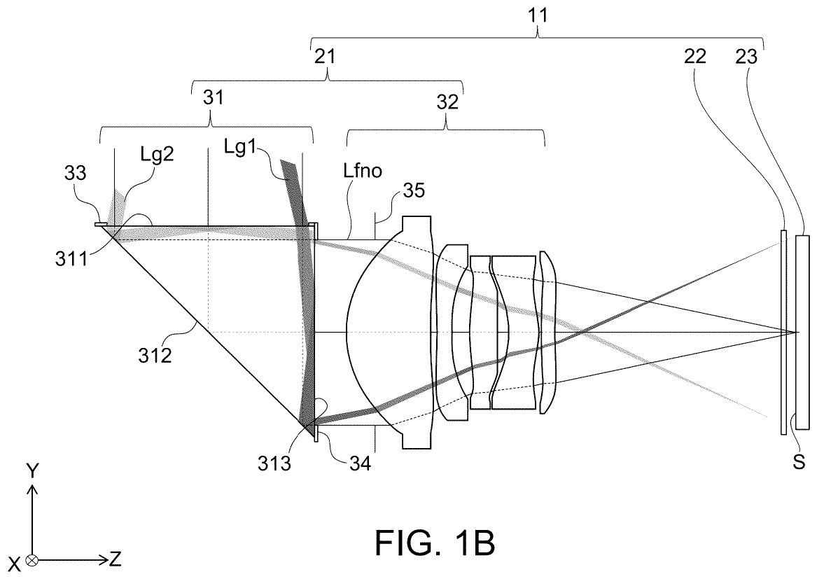

First, an outline of the present disclosure will be described. As shown in FIG. 1A, a camera module 11 applied with the present disclosure includes an imaging lens assembly 21, an optical filter 22, and an image sensor 23 having an imaging surface S. The camera module 11 is stored in a housing 4 to configure an imaging device 1.

In FIG. 1A, a dash-dot line represents an optical axis OA of the imaging lens assembly 21 (hereinafter the same applies). In the description below, a direction along an optical axis OA2, which is included in the optical axis OA and is located on a reflecting side of a prism 31 which will be described later, is denoted as a Z-axis direction. Also, a direction of thickness (i.e., direction of height) of the imaging device 1 is denoted as a Y-axis direction, and a direction perpendicular to the Z-axis and the Y-axis direction as an X-axis direction.

As shown in FIG. 1A, the imaging lens assembly 21 includes the prism 31 and a lens group 32 in order from an object side. The imaging lens assembly 21 further includes a first light-shielding mask 33, a second light-shielding mask 34, and an aperture stop 35.

The prism 31 functions as an optical axis direction changing element that changes an optical axis OA direction. The prism 31 changes the optical axis OA direction by bending light incident from the object side and reflecting the light to an image side. The prism 31 includes an incident surface 311 on which light is incident from the object side, a reflective surface 312 that reflects the light incident on the incident surface 311, and an emitting surface 313 that emits light reflected by the reflective surface 312 to the image side. The reflective surface 312 functions as an optical axis direction changing surface. The reflective surface 312 may be inclined with respect to the incident surface 311 and the emitting surface 312.

The incident surface 311 is disposed on a first optical axis OA1 having a first optical axis direction before being changed (i.e., Y-axis direction). In an example shown in FIG. 1A, the incident surface 311 is perpendicular to the first optical axis OA1.

The reflective surface 312 is disposed on the first optical axis OA1 and a second optical axis OA2 between the incident surface 311 and the emitting surface 313. The reflective surface 312 is disposed to be inclined with respect to the optical axis OA. Specifically, the reflective surface 312 is inclined with respect to the first optical axis OA1, which is located on the incident side of the reflective surface 312, and the second optical axis OA2 which is located on the reflecting side of the reflective surface 312. The first optical axis OA1 on the incident side and the second optical axis OA2 on the reflecting side are connected together at an intersection 312a on the reflective surface 312 to define the optical axis OA. The reflective surface 312, for example, may be disposed at an angle of 45° with respect to the first optical axis OA1 and the second optical axis OA2. In other words, the reflective surface 312 may be disposed to bend the optical axis OA by 90°.

The reflective surface 312 may reflect the light incident from the incident surface 311 with total reflection. Or the prism 31 may reflect the incident light by a reflective film disposed on the reflective surface 312. The reflective film may be formed by coating metal material on the reflective surface 312 by vapor deposition or the like.

The emitting surface 313 is disposed on the second optical axis OA2 having a second optical axis direction after being changed (i.e., Z-axis direction). In the example shown in FIG. 1A, the emitting surface 313 is perpendicular to the second optical axis OA2.

One end of the reflective surface 312 on an opposite side of the incident surface 311 (i.e., edge of the reflective surface 312 in-Y direction) and one end of the emitting surface 313 on the opposite side of the incident surface 311 (i.e., edge of the emitting surface 313 in-Y direction) are connected by a plane part 314 along the second optical axis direction (i.e., Z-axis direction). As will be described below, by providing the plane part 314 on the prism, it is possible to suppress a ghost ray incident on one end of the incident surface 311 on the lens group 32 side from being totally reflected by the emitting surface 313 and then reflected by the reflective surface 312 toward the image side.

The prism 31 may be formed either of glass or resin material. Optical characteristics of the prism 31 may be enhanced when the prism 31 is formed of glass. The prism 31 may become lighter when the prism 31 is formed of resin material.

The lens group 32 is disposed on the second optical axis OA2 on the image side of the prism 31. The lens group 32 includes at least one lens. The lens group 32 converges the light incident from the prism 31 side based on refractive power and emits the light to the image side.

The first light-shielding mask 33 is disposed on the incident surface 311 of the prism 31. A first aperture 311 that partially transmits incident light from the object side is provided on the first light-shielding mask 33.

The second light-shielding mask 34 is disposed on the emitting surface 313 of the prism 31. A second aperture 341 that partially transmits emitted light to the image side is provided on the second light-shielding mask 34.

Considering a balance between countermeasures against the ghost ray, amount of peripheral light, and a change in the F number, one, both, or neither of the first light-shielding mask 33 and the second light-shielding mask 34 may be disposed.

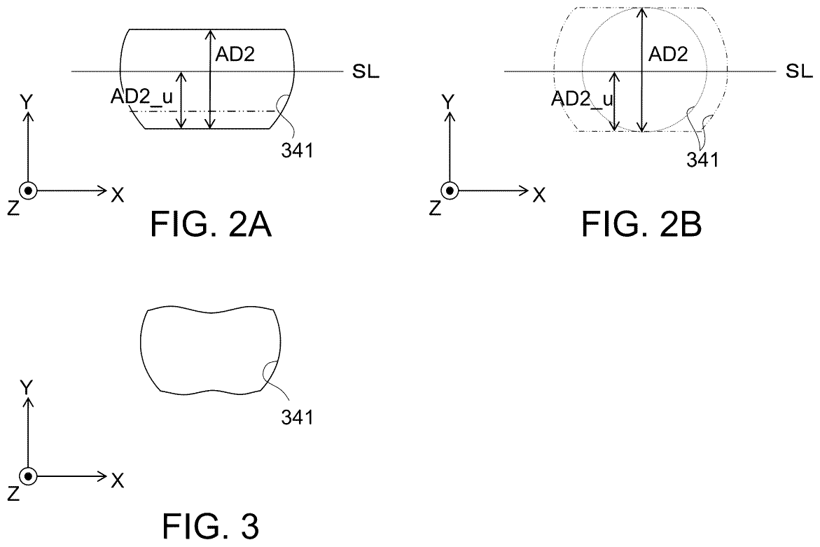

As shown in FIG. 2A, the second aperture 341 has a circular shape where both ends in the Y-axis direction (i.e., first optical axis direction) are missing. Specifically, the second aperture 341 has an asymmetric shape with respect to a straight line SL perpendicular to the Y-axis direction and the Z-axis direction (i.e., second optical axis direction), the straight line SL being defined on an intersection of the second aperture 341 and the Z-axis direction. In other words, the second aperture 341 has a vertically asymmetric shape. The second light-shielding mask 34 provided with such second aperture 341 allows an amount of light shielded by the second light-shielding mask 34 in a lower end (edge in-Y direction) of the emitting surface 313 to be smaller than an amount of light shielded by the second light-shielding mask 34 in an upper end (edge in Y direction) of the emitting surface 313.

As shown in FIG. 3, in some embodiments, both ends of the second aperture 341 in the Y-axis direction have a wavy shape instead of a straight line or an arc in order to avoid image degradation due to ghosting or flare effects caused by knife-edge diffraction.

The image sensor 23 may be a solid-state image sensor such as a Complementary Metal Oxide Semiconductor (CMOS) or a Charge Coupled Device (CCD) and includes the imaging surface S (i.e., an imaging plane) of the imaging lens assembly 21. The image sensor 23 receives light incident from a subject (object side) via the imaging lens assembly 21 and the optical filter 22, photoelectrically converts the light, and outputs a resulting imaging data for a subsequent stage. The optical filter 22, which is disposed between the imaging lens assembly 21 and the image sensor 23, may be, for example, a color correction filter.

Here, the ghost light that arises in the conventional periscope-type prism shape will be described with reference to a conventional camera module 11 shown in FIG. 1B. A central ray (i.e., central luminous flux) Lfno, which is imaged on the center of the image sensor 23, determines the F number of the imaging lens assembly 21. In order to reduce the thickness of the imaging device 1, it is effective to reduce a dimension of the prism 31 in the Y-axis direction. In order to reduce the dimension of the prism 31 in the Y axis direction while suppressing the increase in the F number, it is effective to use the second light-shielding mask 34 to shield peripheral rays outside the central ray Lfno until just beyond the outer end of the central ray Lfno in the Y-axis direction. In other words, as the shape of the second aperture 341 of the second light-shielding mask 34 shown by a dot-dot dashed line in FIG. 2B, the shape of the second aperture 341 may be a shape where both ends in the Y-axis direction are missing symmetrically with reference to the straight line SL. In some embodiments, in a case where an optical system has plenty of peripheral rays, the shape of the second aperture 341 may be circular as shown with a dashed line in FIG. 2B.

In order to further miniaturize the prism 31, it is effective to reduce an effective optical diameter of the prism 31 by adding the first light-shielding mask 33 instead of the second light-shielding mask 34 and further shield the peripheral rays. The first light-shielding mask 33 cuts more peripheral rays compared to the second light-shielding mask 34. Thus, an aperture diameter of the first light-shielding mask 33 may be larger than the central ray Lfno or omit the first light-shielding mask 33 itself.

The prism 31 may be miniaturized through such measures, but a ghost occurs when the prism 31 is miniaturized. FIG. 1B shows optical paths of the ghost Lg1, Lg2 that arise from the prism 31. Optical path Lg1 is a ghost ray that is reflected by the emitting surface 313, reflected by the reflective surface 312, passes through the lens group 32, and then incidents on the image sensor 23. Optical path Lg2 is a ghost ray that is reflected by the reflective surface 312, reflected by the incident surface 311, passes through the lens group 32, and then incidents on the image sensor 23.

In order to reduce these ghosts, a size AD2 of the second aperture 341 of the second light-shielding mask 34 shown in FIG. 2B should be further miniaturized.

Miniaturizing the size AD2 of the second aperture 341 allows cutting the optical paths Lg1 and Lg2 in FIG. 1B. However, in that case, since the central ray Lfno is cut, the F number increases and the brightness of the image formed on the image sensor 23 becomes darker.

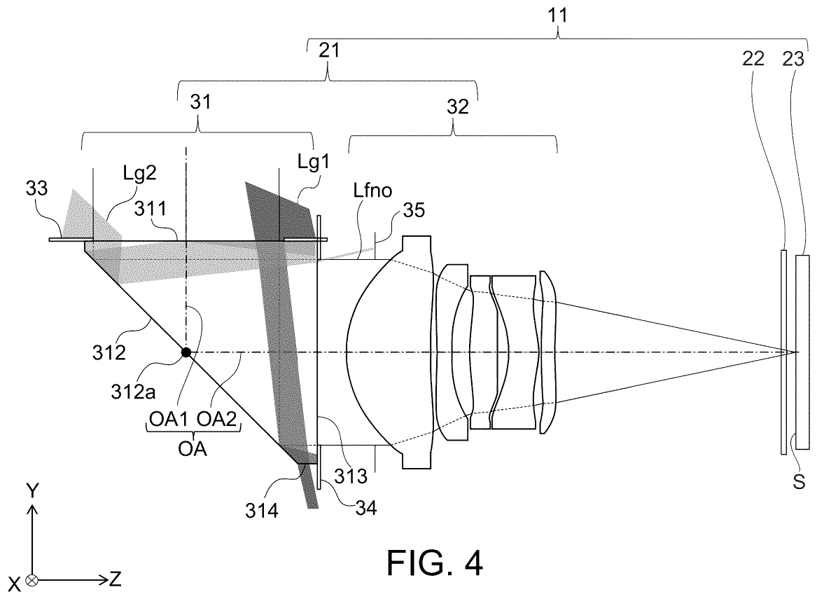

On the other hand, in the camera module 11 according to an example of the present disclosure shown in FIGS. 1A and 4, the shape of the prism 31 is formed in an approximately trapezoidal shape, and the plane part 314 having a length P_W_U is provided at a lower portion of Y direction (i.e., edge in-Y direction) of the prism 31. In the examples shown in FIGS. 1A and 4, the plane part 314 is a flat surface parallel to an XZ plane. Since the plane part 314 is provided on the prism 31, and since the emitting surface 313, which is a first reflective surface of the optical path of ghost Lg1, moves away toward the image sensor 23 side, it is possible to shift a reflecting position of the optical path of ghost Lg1. In this case, the optical path of ghost Lg1 does not reach the image sensor 23. However, the optical path of ghost Lg2 occurs similar to when using the conventional prisms 31 (refer to FIG. 1B) since the position of the incident surface 311 of the prism 311 does not change.

Further, in the camera module 11 according to an example of the present disclosure, the second aperture 341 has an asymmetric shape with respect to the straight line SL as shown in FIG. 2A, so that the central ray Lfno on the upper side in the Y direction side is cut, but the central ray Lfno on the lower side is not cut. Thus, it is possible to reduce the ghost while suppressing the increase in the F number. Also, as shown in FIG. 3, the ghost can be reduced more effectively by forming both ends of the second aperture 341 in the Y-axis direction in the wavy shape.

Further, the camera module 11 may further effectively reduce the ghost Lg1, Lg2 shown in FIG. 4 while suppressing the increase in the F number by satisfying a following inequality (1).

$$P\_in \_L < P\_in \_R \qquad ( 1 )$$

In inequality (1), P_in_L is a distance from the first optical axis OA1 to one end of the incident surface 311 on an opposite side of the lens group 32 (hereinafter the same applies). P_in_R is a distance from the first optical axis OA1 to another end of the incident surface 311 on the lens group 32 side (hereinafter the same applies).

When the value of P_in_L exceeds the upper limit shown in inequality (1), it becomes difficult to reduce the ghost while suppressing the increase in the F number. For example, when the value of P_in_L exceeds the upper limit shown in inequality (1), the ghost ray Lg1 incident on one end of the incident surface 311 on the lens group 32 side is totally reflected by the emitting surface 313, and then reflected to the image side by the reflective surface 312. In this case, in order to shield the ghost ray Lg1 emitted from the reflective surface 312 to the image side using the second light-shielding mask 34, the light-shielding amount of the second light-shielding mask 34 in the lower end (edge in-Y direction) of the emitting surface 313 may be large. However, when the light-shielding amount of the second light-shielding mask 34 in the lower end of the emitting surface 313 becomes large, the F number increases.

Further, the camera module 11 may further effectively reduce the ghost while suppressing the increase in the F number by satisfying a following inequality (2).

$$PW > PH \qquad ( 2 )$$

In inequality (2), PH is a dimension of the prism 31 in the Y-axis direction (i.e., first optical axis direction) (hereinafter the same applies). PW is a dimension of the prism 31 in the Z-axis direction (i.e., second optical axis direction).

When the value of PW falls below the lower limit shown in inequality (2), it becomes difficult to reduce the ghost while suppressing the increase in the F number.

Further, the camera module 11 may further effectively maintain favorable optical characteristics by satisfying a following inequality (3).

$$EFL / S\_d > 1.25 \qquad ( 3 )$$

In inequality (3), EFL is a focal length of the lens group 32 (hereinafter the same applies). S_d is a diagonal image height of the image sensor 23 (hereinafter the same applies).

When the value of EFL/S_d falls below the lower limit shown in inequality (3), it becomes difficult to establish a periscope-type optical system.

Further, the camera module 11 may further effectively maintain favorable optical characteristics by satisfying a following inequality (4).

$$AD 1 \geq AD 2 \qquad ( 4 )$$

In inequality (4), AD1 is a size of the first aperture 331 in the Z-axis direction (i.e., second optical axis direction) (hereinafter the same applies). AD2 is a size of the second aperture 341 in the Y-axis direction (i.e., first optical axis direction).

When the value of AD1 falls below the lower limit shown in inequality (4), it becomes difficult to secure the amount of peripheral light.

Further, the camera module 11 may further effectively reduce the ghost while suppressing the increase in the F number by satisfying a following inequality (5).

$$P\_W \_U > 0.4 mm \qquad ( 5 )$$

In inequality (5), P_W_U is a distance in the Z-axis direction (second optical axis direction) between one end of the reflective surface (i.e., optical axis direction changing surface) 312 on an opposite side of the incident surface 311 and one end of the emitting surface 313 on the opposite side of the incident surface 311 (hereinafter the same applies).

When the value of P_W_U falls below the lower limit shown in inequality (5), it becomes difficult to reduce the ghost while suppressing the F number.

Further, the camera module 11 may further effectively miniaturize the imaging lens assembly 21 while maintaining favorable optical characteristics by satisfying a following inequality (6).

$$LAH \leq AD 1 \qquad ( 6 )$$

In inequality (6), LAH is an aperture diameter of the aperture stop 35 in the Y-axis direction (i.e., first optical axis direction) (hereinafter the same applies).

When the value of LAH exceeds the upper limit shown in inequality (6), it becomes difficult to secure the amount of peripheral light while miniaturizing the prism 31. Also, the F number increases.

Further, the camera module 11 may further effectively maintain favorable optical characteristics by satisfying a following inequality (7).

$$tan ( DFOV / 2 ) < 0.61 \qquad ( 7 )$$

In inequality (7), DFOV is a field of view of the lens group 32 (hereinafter the same applies).

When the value of tan (DFOV/2) exceeds the upper limit shown in inequality (7), it becomes difficult to establish the periscope-type optical system. Also, the size of the prism 31 increases and the thickness of the imaging lens assembly 21 in the Y direction increases.

From a perspective of forming the lens, the aspheric lens among the lenses that form the imaging lens assembly 21, especially the aspheric lens with the inflection point is formed of plastic material but may be formed of glass material as well.

Such a camera module 11 including the imaging lens assembly 21 may be used in compact digital devices (imaging devices) such as mobile phones, wearable cameras, and surveillance cameras.

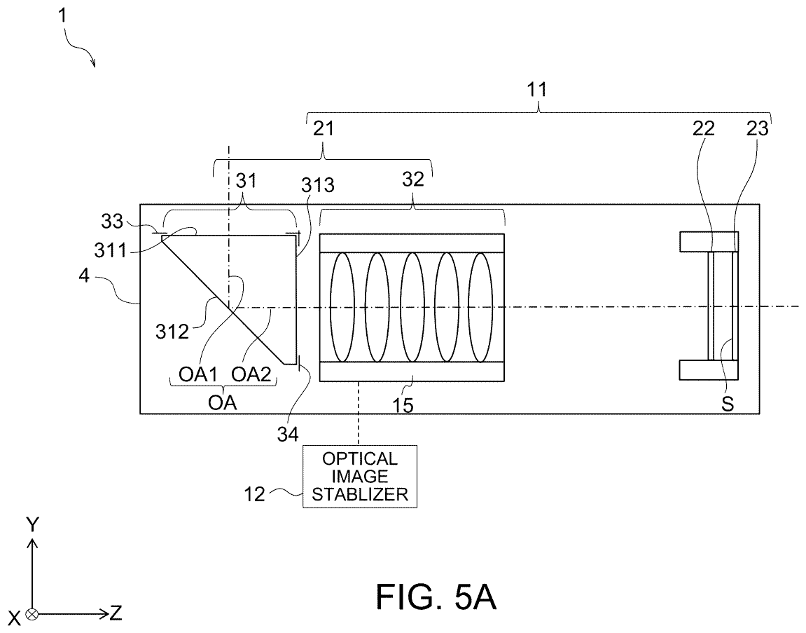

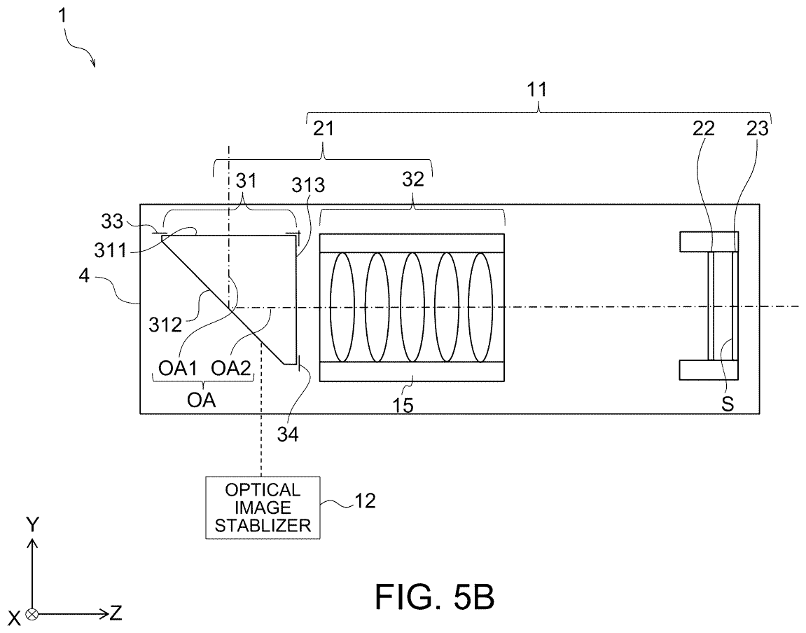

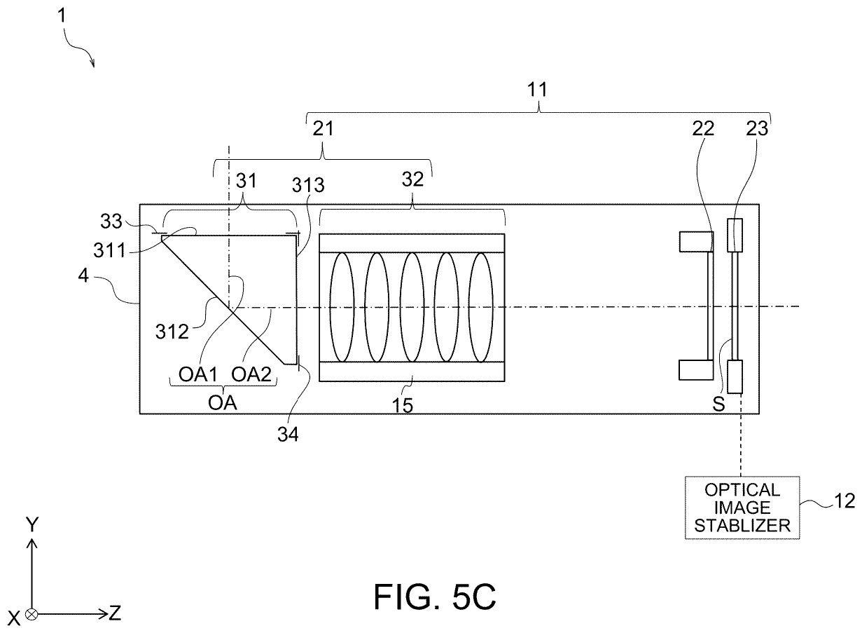

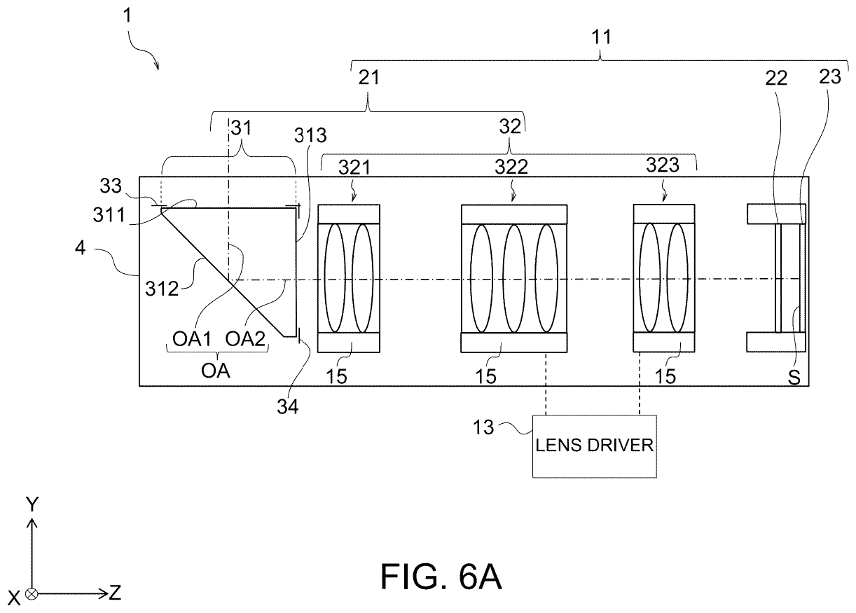

As shown in FIG. 5A, the at least one lens among the lens group 32 may be movable in a direction perpendicular to the second optical axis OA2 by an optical image stabilizer (OIS) provided in the imaging device 1. The OIS 12 reduces image disturbance caused by a camera shake by performing an optical image stabilization that moves at least one lens stored in the barrel 15 together with the barrel 15 in a direction that cancels out the camera shake in a direction perpendicular to the second optical axis OA2. The OIS 12 may include, for example, a drive source such as a motor and a driving force transmission member such as a gear, which transmits the driving force of the drive source to the at least one lens.

As shown in FIG. 5B, the prism 31 may be tiltable by the OIS 12 (i.e., second optical image stabilizer). The OIS 12 may perform optical image stabilization by rotating (i.e., tilting) the prism 31 around a rotating axis in the X-axis direction.

As shown in FIG. 5C, the prism 31 may be fixed and the image sensor 23 may be shiftable by the OIS 12 (i.e., third optical image stabilizer). The OIS 12 may perform optical image stabilization by moving (i.e., shifting) the image sensor 23 in the X-axis and Y-axis directions.

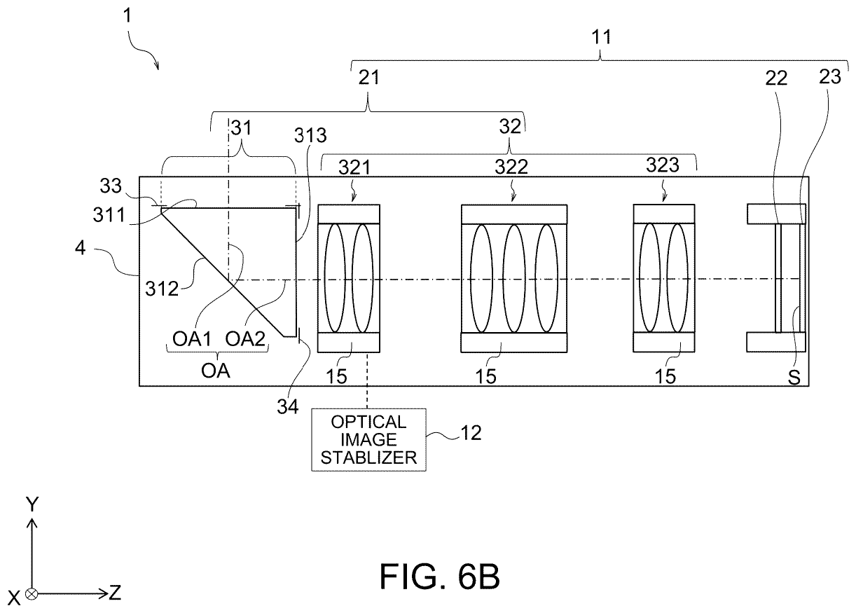

As shown in FIG. 6A, the at least one lens among the lens group 32 may be movable in the Z-axis direction (i.e., second optical axis direction) by a lens driver 13 provided in the imaging device 1. In the example shown in FIG. 6A, the lens group 32 includes, in order from the object side, a first lens group 321, a second lens group 322, and a third lens group 323. The lens driver 13 moves the second lens group 322 and the third lens group 323 in the Z-axis direction. The first lens group 321 is fixed in the Z-axis direction. The lens driver 13 may include, for example, the drive source such as a motor and the driving force transmission member such as a gear, which transmits the driving force of the drive source to the second lens group 322 and the third lens group 323. Moving the second lens group 322 and the third lens group 323 in the Z-axis direction using the lens driver 13 allows a focus operation (i.e., zoom operation) of the second lens group 322 and the third lens group 323.

As shown in FIG. 6B, the prism 31 and the image sensor 23 may be fixed and the lens or a portion of the lens group may be shiftable by the OIS 12. The OIS 12 may perform optical image stabilization by moving (i.e., shifting) the lens or the lens group in the X-axis and the Y-axis directions. In the case of FIG. 6B, the first lens group 321 is shiftable. Further, the lens driver 13 shown in FIG. 6A may be incorporated into the structure of FIG. 6B.

Next, more specific examples to which the present disclosure is applied will be described. In the following examples, “Si” indicates a number of an i-th surface that sequentially increases from the object side toward the imaging surface S side. Optical elements of the corresponding surfaces are indicated by the corresponding surface number “Si”. Denotations of “first surface” or “1st surface” indicate a surface on the object side of the lens or prism, and denotations of “second surface” or “2nd surface” indicate a surface on the imaging surface S side of the lens or the prism. “Ri” indicates a value of a radius of central curvature (mm) of the i-th surface. “Di” indicates a value of a distance on the optical axis OA between the i-th surface and the (i+1)-th surface (mm). “Ndi” indicates a value of a refractive index at d-line (wavelength 587.6 nm) of the material of the optical element having the i-th surface. “vdi” indicates a value of the Abbe number at d-line of the material of the optical element having the i-th surface.

The imaging lens assembly 21 used in the following examples includes lenses having aspheric surfaces. The aspheric shape of the lens is defined by the following equation (8).

$$Z = C \times {h}^{2} / \{ 1 + ( 1 - ( 1 + K ) \times {C}^{2} \times {h}^{2} ) 1 / 2 \} + \sum An \times {h}^{n} \qquad ( 8 )$$

(n=an integer greater than or equal to 3)

In equation (8), Z is a depth of the aspheric surface. C is a paraxial curvature which is equal to 1/R. h is a distance from the optical axis to a lens surface. K is a conic constant (second-order aspheric coefficient). An is an nth-order aspheric coefficient.

### First Example

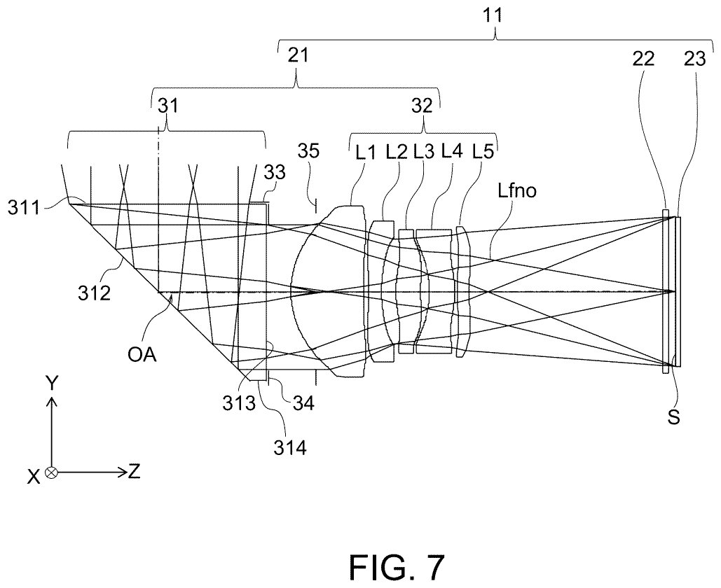

To begin, a first example in which specific numeral values are applied to the camera module 11 shown in FIG. 7 will be described.

In the first example, the imaging lens assembly 21 includes, in order from the object side to the image side, the prism 31 and the lens group 32. The lens group 32 includes, in order from the object side to the image side, a first lens L1 having positive refractive power in a paraxial region facing a convex surface towards the object side, a second lens L2 having negative refractive power in the paraxial region, a third lens L3 having positive refractive power in the paraxial region, a fourth lens L4 having positive refractive power in the paraxial region, and a fifth lens L5 having negative refractive power in the paraxial region. The aperture stop 35 is disposed in the first lens L1.

Table 1 shows a lens data of the first example. In the following tables, units of length and distance of the imaging lens assembly 21 are in mm. Table 2 shows values related to each conditional expression. In Table 2, “D_FNO” is a designed F number of the imaging lens assembly 21 in a state where the first light-shielding mask 33 and the second light-shielding mask 34 that reduce the ghost are not disposed. “R_FNO” is an actual F number of the imaging lens assembly 21 in a state where the first light-shielding mask 33 and the second light-shielding mask 34 are disposed.

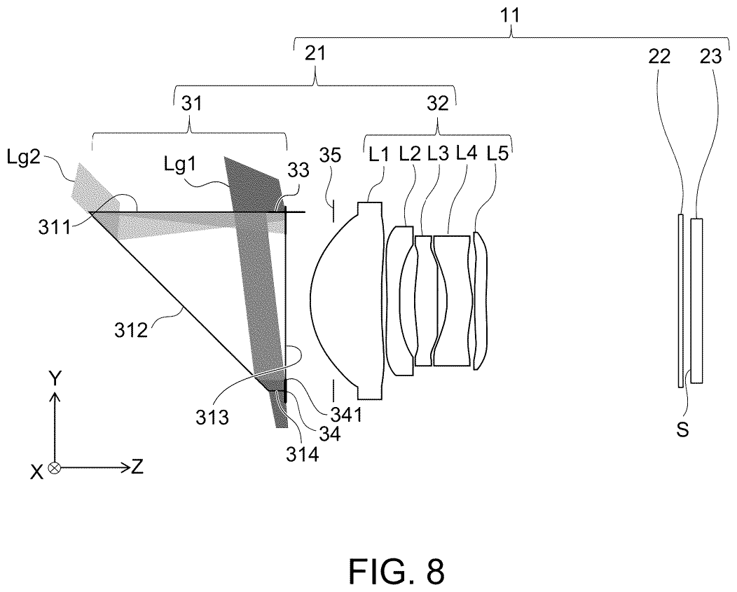

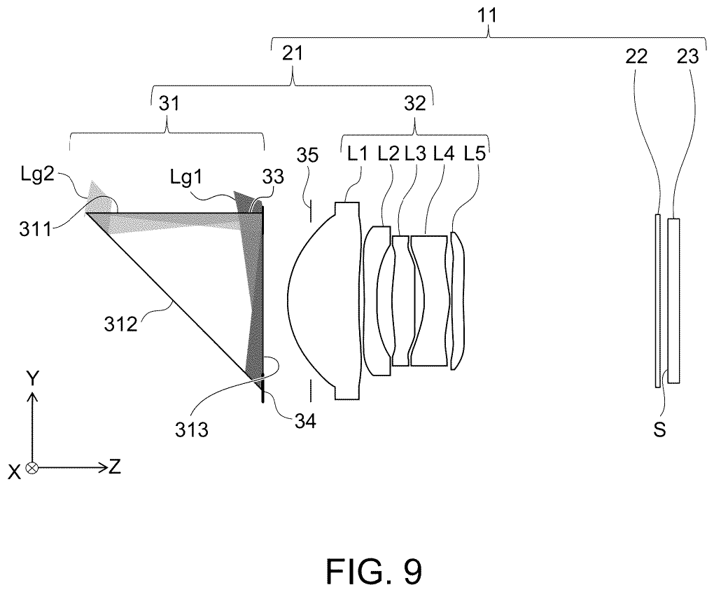

Here, a relationship between “D_FNO” and “R_FNO” will be described. As shown in FIG. 8, in the first example, the shape of the prism 31 is approximately trapezoidal, and the plane part 314 with length P_W_U is provided on the lower portion of the prism 31 in the Y direction. In this case, the reflecting position may be shifted since the emitting surface 313, which is the first reflective surface of the optical path of ghost Lg1, moves away toward the image sensor 23 side. In this case, the optical path of ghost Lg1 does not reach the image sensor 23. Thus, the increase in the F number may be suppressed since there is no need to narrow down the aperture diameter of the second light-shielding mask 34. However, the optical path of ghost Lg2 occurs similar to the optical path of ghost Lg2 that occurs in the shape of the conventional prism as shown in FIG. 9 since the position of the incident surface 311 of the prism 31 does not change. Thus, “R_FNO” becomes slightly greater than “D_FNO”. However, it is possible to make “R_FNO” smaller than “N_C_FNO” which will be described below.

“N_C_FNO” is the F number of the imaging lens assembly 21 of a first comparison example that includes the prism 31 having a shape of the conventional prism and the light-shielding masks 33, 34. The shape of the conventional prism is approximately a right triangle as shown in the prism 31 of FIG. 9. In the case of the first comparison example, “N_C FNO” is larger than “R_FNO” since the aperture diameter of the second light-shielding mask 34 may be small to cut the optical path of ghost Lg1 and Lg2. “S_s” is an image height of the image sensor 23 in a short-side direction. Table 3 shows the aspheric coefficient values of the imaging lens assembly 21. In the aspheric coefficients, “E-i” represents an exponential expression with base 10, i.e., “10⁻ⁱ”. For example, “−6.033138.E-04” represents “−6.033138×10⁻⁴”.

TABLE 1

| | | | | | FOCAL | COMPOSITE |
|---|---|---|---|---|---|---|
| Si | Ri | Di | Ndi | Vdi | LENGTH | FOCAL LENGTH |
| 1 (OBJECT) | INF | INF | | | | |
| 2(INCIDENT SURFACE | INF | 3.600 | 1.785 | 25.720 | | |
| OF PRISM) | | | | | | |
| 3(REFLECTIVE SURFACE | INF | 4.300 | 1.785 | 25.720 | | |
| OF PRISM) | | | | | | |
| 4(EMITTING SURFACE | INF | 2.000 | | | | |
| OF PRISM) | | | | | | |
| 5 (APERTURE STOP) | INF | −1.000 | | | | |
| 6 (1ST SURFACE OF L1) | 3.884 | 2.908 | 1.535 | 5 [symbol] .711 | 7.63 | 15.38 |
| 7(2ND SURFACE OF L1) | 5 [symbol] | 0.204 | | | | |
| 8(1ST SURFACE OF L2) | −11.744 | 0.512 | 1.661 | 20.365 | −6.17 | |
| 9(2ND SURFACE OF L2) | 6.441 | 0.578 | | | | |
| 10(1ST SURFACE OF L3) | 4.362 | 0.984 | 1.661 | 20.365 | 9.50 | |
| 11(2ND SURFACE OF L3) | 12.543 | 0.389 | | | | |
| 12(1ST SURFACE OF L4) | −3.25 [symbol] | 1.010 | 1.616 | 25.785 | 53.85 | |
| 13(2ND SURFACE OF L4) | −3.318 | 0.100 | | | | |
| 14(1ST SURFACE OF L5) | 14.083 | 0.4 [symbol] 0 | 1.614 | 25.592 | −20.02 | |
| 15(2ND SURFACE OF L5) | 6.5077 | 7.774 | | | | |
| 16(1ST SURFACE OF | INF | 0.2 [symbol] 0 | 1.517 | [symbol] 4. [symbol] 67 | | |
| COLOR CORRECTION FILTER) | | | | | | |
| 17(2ND SURFACE OF | INF | 0.300 | | | | |
| COLOR CORRECTION FILTER) | | | | | | |
| 18(IMAGING PLANE) | INF | 0.000 | | | | |

[symbol]

indicates data missing or illegible when filed

TABLE 2

| | |
|---|---|
| S_d | 5.120 |
| S_s | 3.072 |
| EFL | 15.382 |
| D_FNO | 2.403 |
| R_FNO | 2.445 |
| N_C_FNO | 2.476 |
| DFOV | 35.81 |
| LAH | 6.40 |
| PH | 7.20 |
| PW | 7.90 |
| P_in_L | 3.60 |
| P_in_R | 4.30 |
| AD1 | 7.20 |
| AD2 | 5.92 |
| AD2_u | 3.20 |
| P_W_U | 0.70 |
| TAN(DFOV/2) | 0.32 |
| EFL/S_d | 3.00 |

TABLE 3

| Si | 6(1ST SURFACE OF L1) | 7(2ND SURFACE OF L1) | 8(1ST SURFACE OF L2) | 9(2ND SURFACE OF L2) |
|---|---|---|---|---|
| K | 0.215514 | −99.000000 | −14.301137 | −18.833363 |
| A3 | 0 | 0 | 0 | 0 |
| A4 | −6.033138.E−04 | 3.262119.E−03 | 9.116799.E−03 | 5.396230.E−03 |
| A5 | 0 | 0 | 0 | 0 |
| A6 | 2.444479.E−05 | −4.360619.E−04 | −3.845595.E−04 | 1.175859.E−03 |
| A7 | 0 | 0 | 0 | 0 |
| A8 | −6.197635.E−05 | 4.417713.E−05 | −4.736777.E−05 | −2.485130.E−04 |
| A9 | 0 | 0 | 0 | 0 |
| A10 | 1.936027.E−05 | −3.543050.E−06 | 1.143094.E−05 | 1.336525.E−05 |
| A11 | 0 | 0 | 0 | 0 |
| A12 | −3.387850.E−06 | −1.405117.E−06 | 7.576275.E−07 | 8.090341.E−06 |
| A13 | 0 | 0 | 0 | 0 |
| A14 | 2.882763.E−07 | 2.193173.E−07 | −3.483368.E−07 | −1.018893.E−06 |
| A15 | 0 | 0 | 0 | 0 |
| A16 | −1.041445.E−08 | −8.198335.E−09 | 2.565071.E−08 | 2.073750.E−08 |
| A17 | 0 | 0 | 0 | 0 |
| A18 | 0 | 0 | 0 | 0 |
| A19 | 0 | 0 | 0 | 0 |
| A20 | 0 | 0 | 0 | 0 |
| A21 | 0 | 0 | 0 | 0 |
| A22 | 0 | 0 | 0 | 0 |
| A23 | 0 | 0 | 0 | 0 |
| A24 | 0 | 0 | 0 | 0 |
| A25 | 0 | 0 | 0 | 0 |
| A26 | 0 | 0 | 0 | 0 |
| A27 | 0 | 0 | 0 | 0 |
| A28 | 0 | 0 | 0 | 0 |
| A29 | 0 | 0 | 0 | 0 |
| A30 | 0 | 0 | 0 | 0 |
| Si | 10(1ST SURFACE OF L3) | 11(2ND SURFACE OF L3) | 12(1ST SURFACE OF L4) | 13(2ND SURFACE OF L4) |
| K | −0.450004 | −131.523981 | −1.776952 | −15.595034 |
| A3 | 0 | 0 | 0 | 0 |
| A4 | −2.035588.E−02 | −1.210405.E−02 | 8.136438.E−03 | 5.142520.E−03 |
| A5 | 0 | 0 | 0 | 0 |
| A6 | 4.137664.E−05 | −6.481388.E−03 | −2.324604.E−03 | 3.326005.E−03 |
| A7 | 0 | 0 | 0 | 0 |
| A8 | −1.819221.E−04 | 1.268357.E−03 | −3.701039.E−04 | 2.902598.E−04 |
| A9 | 0 | 0 | 0 | 0 |
| A10 | 8.643960.E−05 | −1.011620.E−04 | 3.975478.E−04 | −4.371648.E−04 |
| A11 | 0 | 0 | 0 | 0 |
| A12 | −3.424209.E−05 | 7.073100.E−05 | −7.583073.E−05 | 8.971079.E−05 |
| A13 | 0 | 0 | 0 | 0 |
| A14 | 6.452839.E−06 | −1.935502.E−05 | 5.366054.E−06 | −7.310649.E−06 |
| A15 | 0 | 0 | 0 | 0 |
| A16 | −3.983979.E−07 | 1.633670.E−06 | −5.664760.E−08 | 2.123222.E−07 |
| A17 | 0 | 0 | 0 | 0 |
| A18 | 0 | 0 | 0 | 0 |
| A19 | 0 | 0 | 0 | 0 |
| A20 | 0 | 0 | 0 | 0 |
| A21 | 0 | 0 | 0 | 0 |
| A22 | 0 | 0 | 0 | 0 |
| A23 | 0 | 0 | 0 | 0 |
| A24 | 0 | 0 | 0 | 0 |
| A25 | 0 | 0 | 0 | 0 |
| A26 | 0 | 0 | 0 | 0 |
| A27 | 0 | 0 | 0 | 0 |
| A28 | 0 | 0 | 0 | 0 |
| A29 | 0 | 0 | 0 | 0 |
| A30 | 0 | 0 | 0 | 0 |

| Si | 14(1ST SURFACE OF L5) | 15(2ND SURFACE OF L5) |
|---|---|---|
| K | 7.142507 | −87.067890 |
| A3 | 1.232527.E−02 | 1.713003.E−02 |
| A4 | −1.167341.E−02 | −3.070815.E−02 |
| A5 | −9.912408.E−03 | 7.211293.E−03 |
| A6 | 6.900269.E−03 | 4.787816.E−04 |
| A7 | 1.401135.E−03 | −8.255172.E−05 |
| A8 | −1.437896.E−03 | 7.347086.E−05 |
| A9 | −5.690354.E−04 | −1.071902.E−04 |
| A10 | 4.386108.E−04 | −8.217433.E−05 |
| A11 | −6.367786.E−05 | −1.293986.E−05 |
| A12 | −3.289902.E−06 | 4.121935.E−05 |
| A13 | 1.912944.E−05 | 4.352284.E−06 |
| A14 | −1.217811.E−05 | −9.571297.E−06 |
| A15 | 2.202220.E−06 | 1.808411.E−06 |
| A16 | −1.963366.E−08 | −1.797708.E−08 |
| A17 | 0 | 0 |
| A18 | 0 | 0 |
| A19 | 0 | 0 |
| A20 | 0 | 0 |
| A21 | 0 | 0 |
| A22 | 0 | 0 |
| A23 | 0 | 0 |
| A24 | 0 | 0 |
| A25 | 0 | 0 |
| A26 | 0 | 0 |
| A27 | 0 | 0 |
| A28 | 0 | 0 |
| A29 | 0 | 0 |
| A30 | 0 | 0 |

FIG. 8 shows the shielding of ghosts by the imaging lens assembly 21 according to the first example. FIG. 8 shows the shielding of ghosts by the imaging lens assembly 21 according to the first comparison example.

In the first example, since the prism size (P_W_U) is expanded in the Z-axis direction by the plane part 314 provided on the prism 31, it is possible to suppress the total reflection of ghost ray Lg1, which is incident on one end of the incident surface 311 on the lens group 32 side, by the emitting surface 313. Since the total reflection of the ghost ray Lg1 by the emitting surface 313 can be suppressed, it is possible to reduce the ghost ray Lg1 that is reflected by the reflective surface 312 toward the image side. Since the ghost ray Lg1 reflected by the reflective surface 312 toward the image side can be reduced, it is possible to effectively reduce the ghost ray Lg1 without increasing the light-shielding amount of the second light-shielding mask 34 at the lower end (edge in-Y direction) of the emitting surface 313. On the other hand, the ghost ray Lg2 incident on the other end of the incident surface 311 opposite to the lens group 32 is totally reflected by the incident surface 311 and then travels to the upper end (edge in Y direction) of the emitting surface 313.

In other words, according to the first example, by using the second light-shielding mask 34 (see FIG. 2A) with small light-shielding amount in the lower end of the emitting surface 313, having the vertically asymmetric shape, it is possible to effectively shield the ghost rays Lg1, Lg2.

Further, according to the first example, by using the second light-shielding mask 34 with small light-shielding amount in the lower end of the emitting surface 313, having the vertically asymmetric shape, it is possible not to shield the lower part of the central ray Lfno that determines the F number, and to shield the upper part of the central ray Lfno with a minimal amount of light shielding. This makes it possible to suppress the increase in the F-number and image a bright image. Specifically, according to the first example, the F number R_FNO becomes 2.445 by setting a cross-sectional area of the central ray Lfno on the emitting surface 313 of the prism 31 to 31.074 mm².

The height PH of the prism 31 contributes to the thickness of a smartphone. When the prism 31 is tilted by the OIS 12 (see FIG. 5B), the OIS 12 may be miniaturized by lightening the prism 31. In the first example, the diameter of the central ray Lfno (i.e., aperture diameter LAH of the aperture stop 35) is 6.4 mm. Therefore, by adding a margin of 0.4 mm on the upper end of the prism 31 and a margin of 0.4 mm on the lower end of the prism 31 to 6.4 mm, PH is set to 6.4 mm+0.4 mm+0.4 mm=7.2 mm. PH may be further decreased by reducing the margin as far as manufacturing allows. Also, PH may be increased by increasing the margin if there is room in the size of the housing 4.

On the other hand, in the first comparison example, the prism size (P_W_U) is not expanded in the Z-axis direction since the prism height PH and the size PW of the prism 31 in the Z-axis direction are both 7.2 mm and the plane part 314 is not provided on the prism 31. Thus, as shown in FIG. 9, the ghost ray Lg1, which is incident on one end of the incident surface 311 on the lens group 32 side, is totally reflected by the emitting surface 313. Since the ghost ray Lg1 is totally reflected by the emitting surface 313, the ghost ray Lg1 reflected by the reflective surface 312 toward the image side cannot be reduced. Since the ghost ray reflected by the reflective surface 312 toward the image side cannot be reduced, the ghost ray Lg1 cannot be effectively reduced without increasing the light-shielding amount of the second light-shielding mask 34 in the lower end of the emitting surface 313.

Therefore, in the first comparison example, the ghost rays Lg1, Lg2 cannot be effectively shielded without using the second light-shielding mask 34 (see the dot-dot dashed line in FIG. 2A) having the vertically symmetrical shape and where the light-shielding amount in the lower end and the upper end of the emitting surface 313 are equal.

Accordingly, in the first comparison example, in order to shield the ghost ray Lg1, the size AD2 of the second aperture 341 of the second light-shielding mask 34 may be smaller than the size AD2 in the first example. As a result, in the first comparison example, the lower portion of the central ray Lfno is shielded to a greater extent than in the first example. On the emitting surface 313 of the prism 31, the cross-sectional area of the central ray Lfno that is not shielded by the second light-shielding mask 34 is 32.169 mm². However, since the central ray Lfno is partially shielded by the second light-shielding mask 34 where the size AD2 of the second aperture 341 is 5.54 mm, the actual cross-sectional area of the central ray Lfno is 30.307 mm². Virtually converting the cross-sectional area 30.307 mm² of the central ray Lfno into the diameter of the aperture stop 35 gives 6.211 mm. In this case, the effective F number N_C_FNO is 2.403/6.211*6.4=2.476. Accordingly, in the first comparison example, the F number increases to reduce the ghost, and the brightness of the image becomes dark.

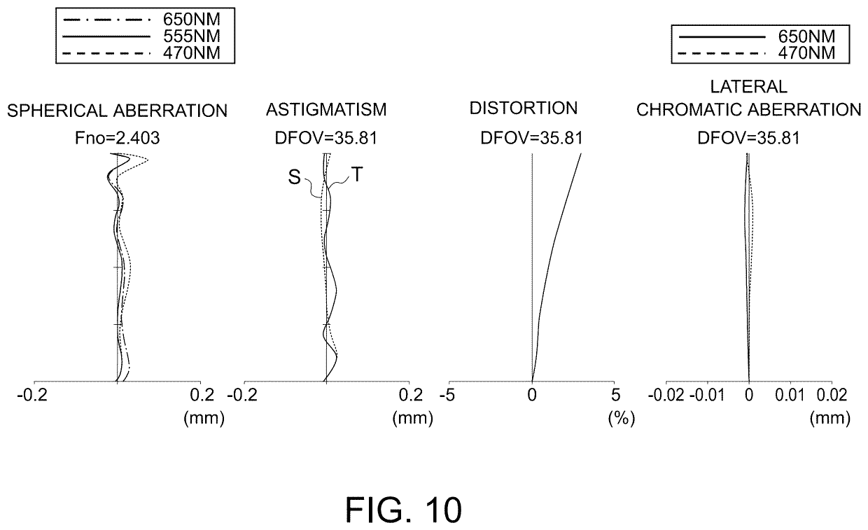

Aberrations in the first example are shown in FIG. 10. FIG. 10 shows, as examples of aberrations, spherical aberration, astigmatism (field curvature), distortion, and lateral chromatic aberration. In each aberration diagram, aberrations are shown with a reference wavelength at 555 nm. In the spherical aberrations, the aberrations are also shown for reference wavelengths at 470 nm and 650 nm. In the aberration diagram for astigmatism, “S” denotes aberration values in a sagittal image plane, and “T” denotes aberration values in a tangential image plane. In the lateral chromatic aberration, a solid line shows lateral chromatic aberration for 650 mm, a dashed line for 470 mm. As can be seen from each aberration diagram, it is clear that the camera module 11 of the first example may satisfactorily correct various aberrations to provide superior optical performance despite being small in size. Notations of the aberrations in the examples below are similar to that of the first example and detailed description will be omitted.

### Second Example

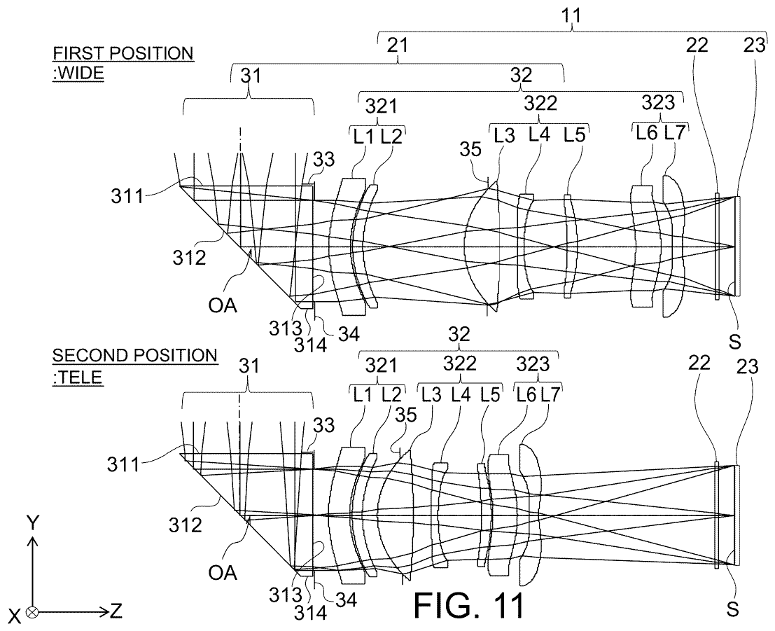

Next, a second example in which specific numeral values are applied to the camera module 11 shown in FIG. 11 will be described.

As shown in FIG. 11, in the second example, the lens group 32 includes, in order from the object side to the image side, a first lens group 321, a second lens group 322, and a third lens group 323. The first lens group 321 includes, in order from the object side to the image side, a first lens L1 and a second lens L2. The second lens group 322 includes, in order from the object side to the image side, a third lens L3, a fourth lens L4, and a fifth lens F5. The third lens group 323 includes, in order from the object side to the image side, a sixth lens L6 and a seventh lens L7. A position of the first lens group 321 is fixed in the optical axis OA direction. The second lens group 322 and the third lens group 323 are movable in the Z-axis direction by the lens driver 13 (see FIG. 6). The aperture stop 35 is disposed on the second lens group 322. FIG. 11 shows the imaging lens assembly 21 when the second lens group 322 and the third lens group 323 are moved to a first position in a wide-angle side and a second position in a telephoto side.

The lens parameters corresponding to those in the first example are as shown in Tables 4-7. In the lens data of Table 4, the lens parameters that differ depending on whether the second lens group 322 and the third lens group 323 are in the first position or the second position are denoted as “ZOOM” instead of listing specific values. Specific values of “ZOOM” are listed in Table 5. In Table 6 that shows values related to the conditional expressions, values corresponding to the first position and the second position are shown for parameters that differ depending on whether the second lens group 322 and the third lens group 323 are in the first position or the second position.

TABLE 4

| | | | | | FOCAL | COMPOSITE |
|---|---|---|---|---|---|---|
| Si | Ri | Di | Ndi | Vdi | LENGTH | FOCAL LENGTH |
| 1 (OBJECT) | INF | INF | | | | |
| 2(INCIDENT SURFACE | INF | 3.800 | 1.785 | 25.720 | | |
| OF PRISM) | | | | | | |
| 3(REFLECTIVE SURFACE | INF | 4.600 | 1.785 | 25.720 | | |
| OF PRISM) | | | | | | |
| 4(EMITTING SURFACE | INF | 1.000 | | | | |
| OF PRISM) | | | | | | |
| 5 (1ST SURFACE OF L1) | 8. [symbol] 323 | 1.317 | 1.544 | 56.332 | − [symbol] 9.00 | ZOOM |
| 6(2ND SURFACE OF L1) | 6.315 | 0.149 | | | | |
| 7(1ST SURFACE OF L2) | 6.776 | 0.635 | 1.671 | 19.23 [symbol] | −362.36 | |
| 8(2ND SURFACE OF L2) | 6.343 | ZOOM | | | | |
| 9 (APERTURE STOP AND | 4.868 | 2.217 | 1.497 | 81.5 [symbol] 0 | [symbol] .92 | |
| 1ST SURFACE OF L3) | | | | | | |
| 10(2ND SURFACE OF L3) | −43.155 | 1.115 | | | | |
| 11(1ST SURFACE OF L4) | [symbol] .776 | 0.420 | 1. [symbol] 16 | 25.785 | −20.78 | |
| 12(2ND SURFACE OF L4) | 10.737 | 2.680 | | | | |
| 13(1ST SURFACE OF L5) | −23.718 | 0.621 | 1.567 | [symbol] 7. [symbol] | 3 [symbol] .49 | |
| 14(2ND SURFACE OF L5) | −11.019 | ZOOM | | | | |
| 15(1ST SURFACE OF L6) | −7.77 [symbol] 1 | 1.676 | 1.671 | 19.230 | [symbol] | |
| 16(2ND SURFACE OF L6) | −5.5653 | 0.714 | | | | |
| 17(1ST SURFACE OF L7) | [symbol] 6.7 [symbol] | 0.608 | 1.644 | [symbol] . [symbol] 2 | −11.98 | |
| 18(2ND SURFACE OF L7) | 4.54 [symbol] 8 | ZOOM | | | | |
| 19(1ST SURFACE OF | INF | 0.210 | 1.517 | 64.1 [symbol] 7 | | |
| COLOR CORRECTION FILTER) | | | | | | |
| 20(2ND SURFACE OF | INF | 1.000 | | | | |
| COLOR CORRECTION FILTER) | | | | | | |
| 21(IMAGING PLANE) | INF | 0.000 | | | | |

[symbol]

indicates data missing or illegible when filed

TABLE 5

| | FIRST | SECOND |
|---|---|---|
| ZOOM | POSITION | POSITION |
| 8(2ND SURFACE OF L2) | 6.278 | 0.936 |
| 14(2ND SURFACE OF L5) | 3.617 | 0.100 |
| 18(2ND SURFACE OF L7) | 2.047 | 10.906 |
| COMPOSITE FOCAL LENGTH | 16.327 | 27.208 |

TABLE 6

| | |
|---|---|
| FIRST POSITION | SECOND POSITION |

| | |
|---|---|
| S_d | 5.120 |
| S_s | 3.072 |

| | | |
|---|---|---|
| EFL | 16.327 | 27.208 |
| D_FNO | 2.408 | 3.606 |
| D_W_FNO | 2.408 | 3.674 |
| R_FNO | 2.450 | 3.770 |
| N_C_FNO | 2.475 | 3.836 |
| DFOV | 34.44 | 21.11 |

| | |
|---|---|
| LAH | 7.30 |
| PH | 7.60 |
| PW | 8.30 |
| P_in_L | 3.80 |
| P_in_R | 4.50 |
| AD1 | 7.60 |
| AD2 | 6.28 |
| AD2_u | 3.40 |
| P_W_U | 0.70 |

| | | |
|---|---|---|
| TAN(DFOV/2) | 0.31 | 0.19 |
| EFL/S_d | 3.19 | 5.31 |

TABLE 7

| Si | 5(1ST SURFACE OF L1) | 6(2ND SURFACE OF L1) | 7(1ST SURFACE OF L2) | 8(2ND SURFACE OF L2) |
|---|---|---|---|---|
| K | 0.316759 | −0.701261 | 0 | 0 |
| A4 | −5.666581.E−04 | 3.492146.E−04 | −7.363833.E−04 | −1.640135.E−03 |
| A6 | −1.915405.E−05 | −6.888810.E−05 | −2.312629.E−05 | 1.512725.E−05 |
| A8 | −1.533744.E−06 | −1.458122.E−06 | 3.204984.E−06 | 3.180646.E−06 |
| A10 | 8.880136.E−08 | 1.131149.E−07 | −4.536515.E−08 | −3.148360.E−08 |
| A12 | −1.640498.E−09 | −1.790786.E−09 | 5.610432.E−11 | −2.279974.E−11 |
| A14 | 0 | 0 | 0 | 0 |
| A16 | 0 | 0 | 0 | 0 |
| A18 | 0 | 0 | 0 | 0 |
| A20 | 0 | 0 | 0 | 0 |
| | 9(APERTURE STOP AND | | | |
| Si | 1ST SURFACE OF L3) | 10(2ND SURFACE OF L3) | 11(1ST SURFACE OF L4) | 12(2ND SURFACE OF L4) |
| K | −0.364988 | −4.500335 | −22.868110 | 0.939586 |
| A4 | 2.354966.E−04 | 1.591416.E−04 | −3.054580.E−04 | 9.957505.E−04 |
| A6 | 6.985353.E−06 | −6.194409.E−05 | −1.951430.E−04 | −1.335171.E−04 |
| A8 | −9.455614.E−07 | 4.869203.E−06 | 4.858518.E−05 | 6.467115.E−05 |
| A10 | 5.329969.E−08 | −3.350219.E−08 | −1.747947.E−06 | −4.056289.E−06 |
| A12 | −6.306317.E−10 | −3.757760.E−09 | −1.437551.E−08 | 2.721861.E−07 |
| A14 | 0 | 0 | 0 | 0 |
| A16 | 0 | 0 | 0 | 0 |
| A18 | 0 | 0 | 0 | 0 |
| A20 | 0 | 0 | 0 | 0 |
| Si | 13(1ST SURFACE OF L5) | 14(2ND SURFACE OF L5) | 15(1ST SURFACE OF L6) | 16(2ND SURFACE OF L6) |
| K | 52.781067 | −1.322106 | −5.864465 | −9.499126 |
| A4 | −4.512356.E−04 | −6.327279.E−04 | 2.420103.E−03 | −3.031997.E−03 |
| A6 | −8.250833.E−05 | −5.916405.E−05 | −1.422475.E−04 | 1.548547.E−03 |
| A8 | 9.479638.E−06 | −2.098413.E−06 | 6.829473.E−05 | −5.363880.E−04 |
| A10 | 2.359041.E−07 | 5.987218.E−07 | −2.721973.E−05 | 1.299284.E−04 |
| A12 | 1.843753.E−07 | 1.203593.E−07 | 5.778347.E−06 | −2.129699.E−05 |
| A14 | 0 | 0 | −6.504826.E−07 | 2.244020.E−06 |
| A16 | 0 | 0 | 3.891033.E−08 | −1.360810.E−07 |
| A18 | 0 | 0 | −1.071956.E−09 | 3.807549.E−09 |
| A20 | 0 | 0 | 7.758248.E−12 | −2.023157.E−11 |

| Si | 17(1ST SURFACE OF L7) | 18(2ND SURFACE OF L7) |
|---|---|---|
| K | −74.530615 | −20.728480 |
| A4 | −3.352453.E−02 | −1.283978.E−02 |
| A6 | 8.946656.E−03 | 1.392412.E−03 |
| A8 | −2.590982.E−03 | −5.678398.E−05 |
| A10 | 6.068396.E−04 | −1.133242.E−05 |
| A12 | −1.024708.E−04 | 2.273968.E−06 |
| A14 | 1.164044.E−05 | −1.717243.E−07 |
| A16 | −8.235503.E−07 | 5.123400.E−09 |
| A18 | 3.200982.E−08 | 1.040691.E−11 |
| A20 | −5.101371.E−10 | −2.449676.E−12 |

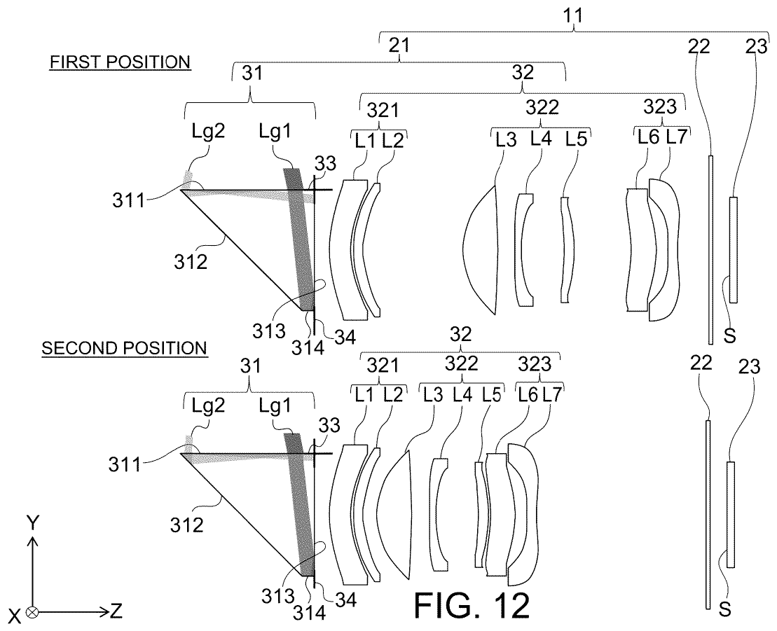

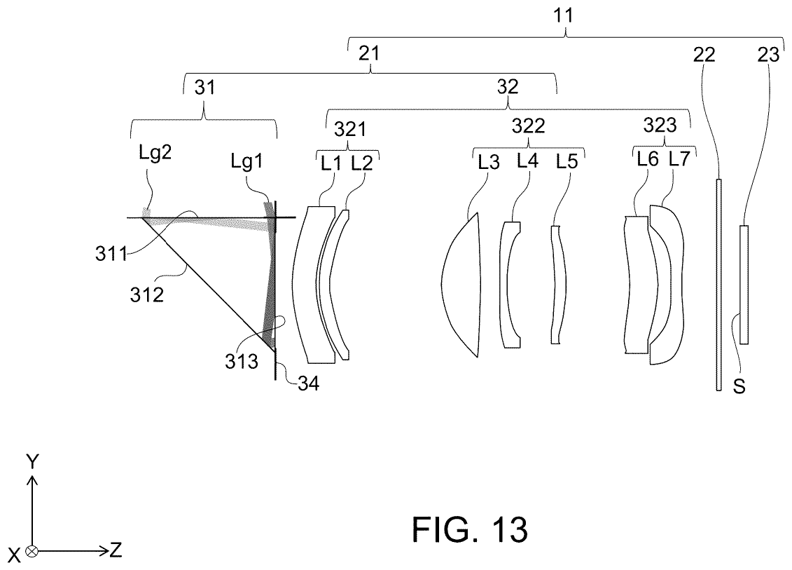

FIG. 12 shows the shielding of ghosts by the imaging lens assembly 21 according to the second example. FIG. 13 shows the shielding of ghosts by the imaging lens assembly 21 according to a second comparison example.

In the second example, “D_W_FNO” in FIG. 6 is the F number when the size of the prism 31 is determined based on a luminous flux diameter of the central ray Lfno when the second lens group 322 and the third lens group 323 are positioned in the first position (i.e., wide-angle side). “D_W_FNO” is based on an assumption that a portion of the central ray Lfno is shielded when the second lens group 322 and the third lens group 323 are positioned in the second position (i.e., telephoto side). In other words, “D_W_FNO” in the second position of the telephoto side is greater than “D_FNO”. This is an effective way to prioritize lowering the height in the Y direction by reducing the size of the prism 31.

Specifically, by setting the cross-sectional area of the central ray Lfno on the emitting surface 313 of the prism 31 to 36.108 mm² when the second lens group 322 and the third lens group 323 are positioned in the first position, the F number D_W_FNO can be set to 2.408. Since the size of the prism 31 is determined based on the luminous flux diameter in the case of the first position, the cross-sectional area of the central ray Lfno is not shielded on the emitting surface 313 of the prism 31. Thus, in the first position, the F number D_W_FNO is equal to the F number D_FNO. Further, by setting the cross-sectional area of the central ray Lfno on the emitting surface 313 of the prism 31 to 43.074 mm² when the second lens group 322 and the third lens group 323 are positioned in the second position, the F number D_W_FNO can be set to 3.674.

As described above, in the second example, the height PH of the prism 31 may be designed based on the luminous flux diameter of the central ray Lfno that passes through the aperture stop 35 when the second lens group 322 and the third lens group 323 are positioned in the first position (i.e., wide-angle side). For example, when the luminous flux diameter of the central ray Lfno that passes through the aperture stop 35 is 6.78 mm when the second lens group 322 and the third lens group 323 are positioned in the first position, the height PH of the prism 31 may be designed to be 7.58 mm by adding a margin of 0.4 mm on the upper end side of the prism 31 and a margin of 0.4 mm on the lower end side to 6.78 mm. In this case, the height PH of the prism 31 can be reduced.

In addition, in the second example, since the prism size (P_W_U) is expanded in the Z-axis direction by the plane part 314 provided on the prism 31, as shown in FIG. 12, it is possible to suppress the ghost ray Lg1 incident on one end of the incident surface 311 on the lens group 32 side from reflecting on the emitting surface 313 with total reflection. As a result, according to the second example, as in the first example, the ghost rays Lg1, Lg2 can be effectively shielded by using the second light-shielding mask 34 (see FIG. 2A) having the vertically asymmetric shape where the light-shielding amount is small at the lower end of the emitting surface 313. Further, according to the second example, the increase in the F number can be suppressed by using the second light-shielding mask 34 where the light-shielding amount is small at the lower end of the emitting surface 313.

Specifically, by setting the cross-sectional area of the central ray Lfno on the emitting surface 313 of the prism 31 to 34.871 mm² when the second lens group 322 and the third lens group 323 are positioned in the first position, the F number R_FNO can be set to 2.450. Further, by setting the cross-sectional area of the central ray Lfno on the emitting surface 313 of the prism 31 to 40.918 mm² when the second lens group 322 and the third lens group 323 are positioned in the second position, the F number R_FNO can be set to 3.770.

On the other hand, in the second comparison example, the prism size (P_W_U) is not expanded in the Z-axis direction since the prism height PH and the size PW of the prism 31 in the Z-axis direction are both 7.6 mm and the plane part 314 is not provided on the prism 31. Thus, as shown in FIG. 13, the ghost ray Lg1, which is incident on one end of the incident surface 311 on the lens group 32 side, is totally reflected by the emitting surface 313. Accordingly, in the second comparison example, the ghost rays Lg1, Lg2 cannot be effectively shielded without using the second light-shielding mask 34 having the vertically symmetric shape (see the dot-dot dashed line in FIG. 2A). Therefore, in the second comparison example, the size AD2 of the second aperture 341 of the second light-shielding mask 34 may be smaller than the size AD2 in the second example in order to shield the ghost ray Lg1. As a result, in the second comparison example, the F number increases in order to reduce the ghost. Specifically, when the second lens group 322 and the third lens group 323 are positioned in the first position, the cross-sectional area of the central ray Lfno on the emitting surface 313 of the prism 31 is 34.186 mm² and the F number N_C_FNO is 2.475. When the second lens group 322 and the third lens group 323 are positioned in the second position, the cross-sectional area of the central ray Lfno on the emitting surface 313 of the prism 31 is 39.526 mm² and the F number N_C FNO is 3.836. In other words, the F number is greater than the effective F number R_FNO of the second example.

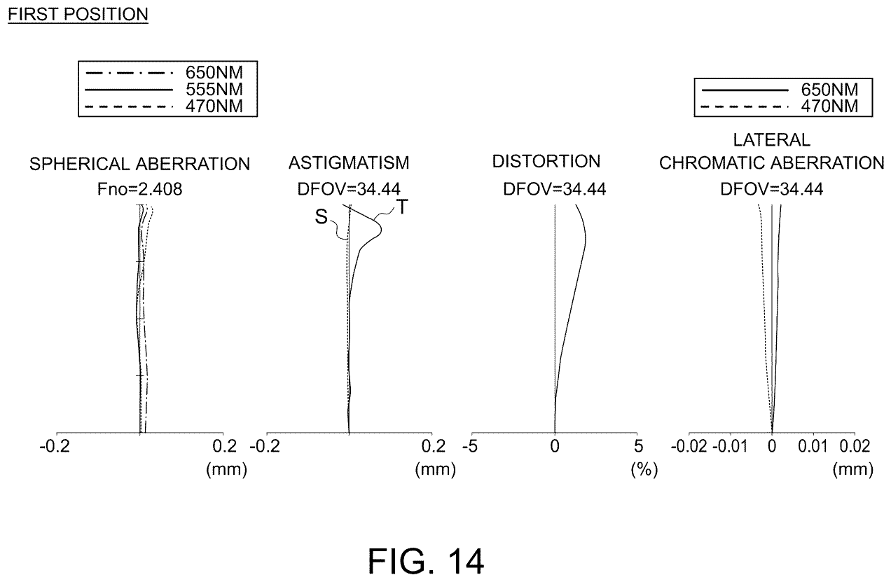

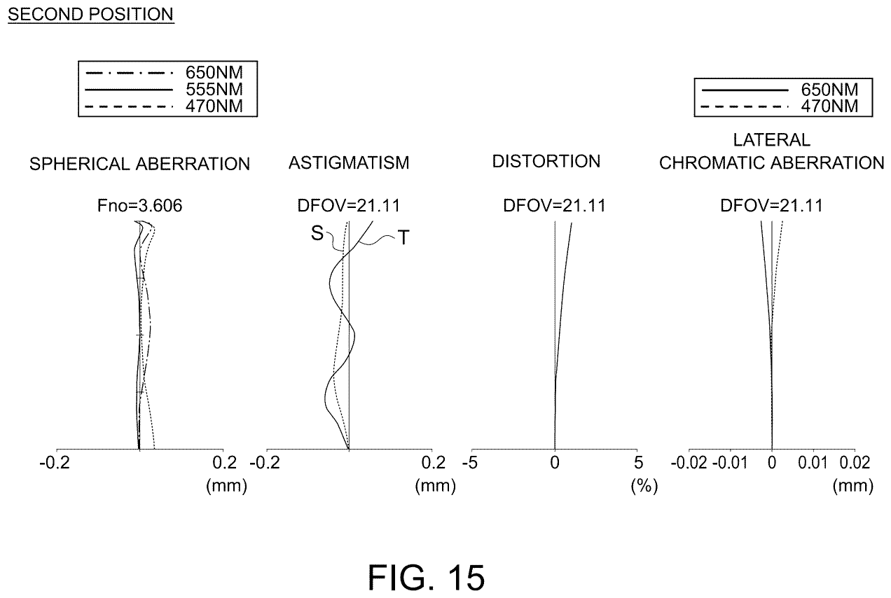

Aberrations in the second example are shown in FIGS. 14-15. FIG. 14 shows aberrations when the second lens group 322 and the third lens group 323 are positioned in the first position. FIG. 15 shows aberrations when the second lens group 322 and the third lens group 323 are positioned in the second position.

According to the imaging lens assembly 21 of the second example, a degree of freedom in designing the camera module 11 may be further increased while obtaining the same effects as in the first example.

### Third Example

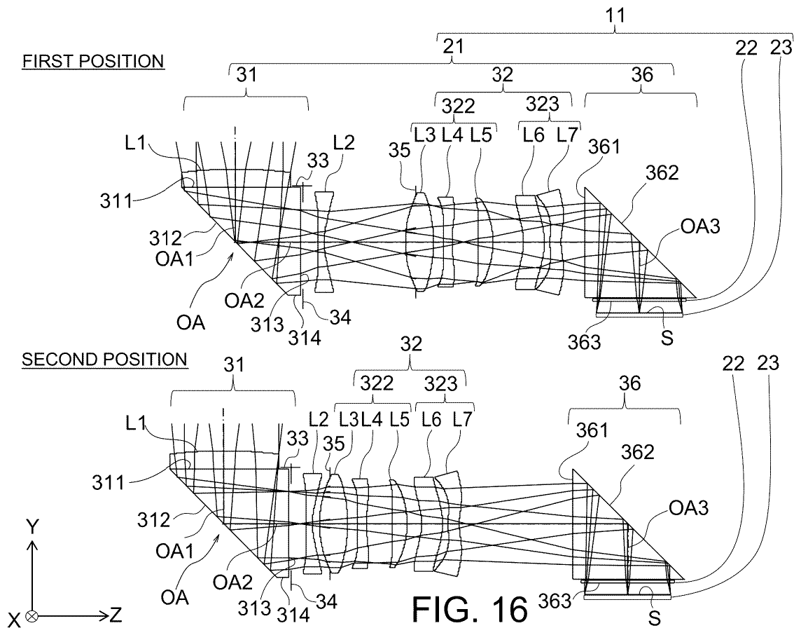

Next, a third example in which specific numeral values are applied to the camera module 11 shown in FIG. 16 will be described.

As shown in FIG. 16, in the third example, the imaging lens assembly 21 includes, in order from the object side to the image side, the first lens L1, the prism 31, the second lens L2, the second lens group 322, the third lens group 323, and a second prism 36. The second lens group 322 includes, in order from the object side to the image side, the third lens L3, the fourth lens L4, and the fifth lens L5. The third lens group 323 includes, in order from the object side to the image side, the sixth lens L6 and a seventh lens L7.

The first lens L1 is a lens having positive refractive power. The first lens L1 may face a convex surface toward the object side. A first surface of the first lens L1 is convex and a second surface is planar. The second surface of the first lens L1 is bonded to the incident surface 311 of the prism 31 with an adhesive. The first lens L1 is formed of glass.

Alternatively, the prism 31 may be formed of resin material. In that case, the first lens L1 is formed of resin material and have the same linear expansion coefficient with respect to temperature change as the prism 31.

Alternatively, the first lens L1 may be formed of glass and the prism 31 of resin material. In that case, since there is a difference in the linear expansion coefficient between glass and resin material, the first lens L1 may be bonded to the prism 31 using an elastic adhesive, or a thin air layer may be provided between the first lens L1 and the prism 31 so that the first lens L1 is not held to the prism 31 by the adhesive.

The position of the second lens L2 is fixed in the optical axis OA direction. The second lens group 322 and the third lens group 323 are movable in the Z-axis direction by the lens driver 13 (see FIG. 6A). The aperture stop 35 is disposed in the second lens group 322.

The second prism 36 functions as a second optical axis direction changing element that changes the optical axis OA direction. The second prism 36 changes the optical axis OA direction by bending the light incident from the third lens group 323 side (i.e., object side) and reflecting the light towards the image side. The image sensor 23 is disposed in the −Y direction with respect to the second prism 36. The imaging surface S of the image sensor 23 is perpendicular to the Y-axis direction.

The second prism 36 includes a second incident surface 361 in which light incidents from the third lens group 323 side, a second reflective surface 362 that reflects light incident on the second incident surface 361 toward the image side, and a second emitting surface 363 that emits the light reflected by the second reflective surface 362 toward the image side.

The second incident surface 361 is disposed on the second optical axis OA2. The second reflective surface 362 is disposed on the second optical axis OA2 on the incident side of the second reflective surface 362 and is disposed on a third optical axis OA3 on the reflective side of the second reflective surface 362. The second reflective surface 362 is disposed to be inclined with respect to the second optical axis OA2 and the third optical axis OA3. The second reflective surface 362 may, for example, be disposed at an inclination of 45° with respect to the second optical axis OA2 and the third optical axis OA3. In other words, the second reflective surface 362 may be disposed to bend the optical axis OA by 90°.

The second reflective surface 362 may reflect the light incident from the second incident surface 361 with total reflection. In some embodiments, the second prism 36 may reflect the incident light by a reflective film disposed on the second reflective surface 362.

The second emitting surface 363 is perpendicular to the third optical axis OA3.

The lens parameters corresponding to those in the first and the second examples are as shown in Tables 8-11.

In the configuration of the third example, since the first lens L1 is added to the prism 31, it is impossible to provide the OIS that tilts the prism 31. It is also impossible to provide the OIS that tilts the second prism 36 since the light rays that are focused on the imaging surface S pass through the second prism 36. Thus, a sensor shift stabilizer presented in FIG. 5C or a lens inner stabilizer presented in FIG. 6B is effective.

TABLE 8

| | | | | | FOCAL | COMPOSITE |
|---|---|---|---|---|---|---|
| Si | Ri | Di | Ndi | Vdi | LENGTH | FOCAL LENGTH |
| 1 (OBJECT) | INF | INF | | | | |
| 2(1ST SURFACE OF L1) | 31.6040 | [symbol] . [symbol] 30 | 2. [symbol] 3 | 28.316 | 56.68 | ZOOM |
| 3(INCIDENT SURFACE | INF | 3.900 | [symbol] .805 | 2 [symbol] .4 [symbol] | | |
| OF PRISM AND | | | | | | |
| 2ND SURFACE OF L1) | | | | | | |
| 4(REFLECTIVE SURFACE | INF | 4.600 | 1. [symbol] | 26. [symbol] 6 | | |
| OF PRISM) | | | | | | |
| 5(EMITTING SURFACE | INF | [symbol] . [symbol] 82 | | | | |
| OF PRISM) | | | | | | |
| 6(1ST SURFACE OF L2) | 16.0 [symbol] 4 | 0.450 | 1. [symbol] | 56.332 | −12. [symbol] | |
| 7(2ND SURFACE OF L2) | 4.64 [symbol] | ZOOM | | | | |
| 8 | INF | 0.750 | | | | |
| 9(APERTURE STOP) | INF | −0.7 [symbol] 0 | | | | |
| 10(1ST SURFACE OF L3) | 7.609 | 2.005 | 1.497 | [symbol] 1.560 | 9.33 | |
| 11(2ND SURFACE OF L3) | −10. [symbol] 8 [symbol] | 0.697 | | | | |
| 12(1ST SURFACE OF L4) | 25.906 | 0. [symbol] | 1.671 | 19.230 | −22. [symbol] 0 | |
| 13(2ND SURFACE OF L4) | 9.599 | 1.373 | | | | |
| 14(1ST SURFACE OF L5) | −6 [symbol] .208 | 1. [symbol] 40 | 1. [symbol] 67 | 87. [symbol] | 11.79 | |
| 15(2ND SURFACE OF L5) | − [symbol] .1 [symbol] 19 | ZOOM | | | | |
| 16(1ST SURFACE OF L6) | −4.3290 | 1.500 | 1.571 | 19.230 | −103.43 | |
| 17(2ND SURFACE OF L6) | −5.259 [symbol] | 0.40 [symbol] | | | | |
| 18(1ST SURFACE OF L7) | 6. [symbol] 1 | 0.7 [symbol] | 1.544 | 56.332 | −17.03 | |
| 19(2ND SURFACE OF L7) | 3.78 [symbol] 7 | ZOOM | | | | |
| 20(INCIDENT SURFACE | INF | 3.950 | 2. [symbol] 3 | 28.316 | | |
| OF 2ND PRISM) | | | | | | |
| 21(REFLECTIVE SURFACE | INF | 3.950 | 2. [symbol] 3 | 28.316 | | |
| OF 2ND PRISM) | | | | | | |
| 22(EMITTING SURFACE | INF | 0.100 | | | | |
| OF 2ND PRISM) | | | | | | |
| 23(1ST SURFACE OF | INF | 0.210 | 1.517 | [symbol] 4.1 [symbol] 7 | | |
| COLOR CORRECTION FILTER) | | | | | | |
| 24(2ND SURFACE OF | INF | 0.790 | | | | |
| COLOR CORRECTION FILTER) | | | | | | |
| 25(IMAGING PLANE) | INF | 0.000 | | | | |

[symbol]

indicates data missing or illegible when filed

TABLE 9

| | FIRST | SECOND |
|---|---|---|
| ZOOM | POSITION | POSITION |
| 7(2ND SURFACE OF L2) | 5.814 | 0.504 |
| 15(2ND SURFACE OF L5) | 2.238 | 1.036 |
| 19(2ND SURFACE OF L7) | 1.660 | 8.172 |
| COMPOSITE FOCAL LENGTH | 16.332 | 27.215 |

TABLE 10

| | |
|---|---|
| FIRST POSITION | SECOND POSITION |

| | |
|---|---|
| S_d | 5.120 |
| S_s | 3.072 |

| | | |
|---|---|---|
| EFL | 16.332 | 27.215 |
| D_FNO | 2.393 | 3.349 |
| D_W_FNO | 2.393 | 3.349 |
| R_FNO | 2.444 | 3.523 |
| N_C_FNO | 2.461 | 3.656 |
| DFOV | 35.65 | 21.21 |

| | |
|---|---|
| LAH | 6.70 |
| PH | 7.80 |
| PW | 8.50 |
| P_in_L | 3.90 |
| P_in_R | 4.60 |
| AD1 | 7.80 |
| AD2 | 5.75 |
| AD2_u | 3.40 |
| P_W_U | 0.70 |

| | | |
|---|---|---|
| TAN(DFOV/2) | 0.32 | 0.19 |
| EFL/S_d | 3.19 | 5.32 |

TABLE 11

| Si | 6(1ST SURFACE OF L2) | 7(2ND SURFACE OF L2) | 10(1ST SURFACE OF L3) | 11(2ND SURFACE OF L3) |
|---|---|---|---|---|
| K | −81.534717 | −8.749520 | −0.379916307 | 3.952981192 |
| A4 | −1.125657.E−02 | −5.275915.E−03 | 1.481014.E−04 | 2.259683.E−04 |
| A6 | 1.867699.E−03 | 9.854714.E−04 | −9.841694.E−06 | 1.041277.E−05 |
| A8 | −1.743052.E−04 | −3.345162.E−06 | 6.643142.E−07 | 7.248167.E−06 |
| A10 | −5.859258.E−06 | −4.536626.E−05 | 3.768912.E−07 | −1.129011.E−06 |
| A12 | 4.480681.E−06 | 1.212568.E−05 | −4.335980.E−08 | 3.173778.E−08 |
| A14 | −6.519596E−07 | −1.654753E−06 | 0 | 0 |
| A16 | 4.859330E−08 | 1.299488E−07 | 0 | 0 |
| A18 | −1.902529E−09 | −5.582421E−09 | 0 | 0 |
| A20 | 3.104024E−11 | 1.020637E−10 | 0 | 0 |
| Si | 12(1ST SURFACE OF L4) | 13(2ND SURFACE OF L4) | 14(1ST SURFACE OF L5) | 15(2ND SURFACE OF L5) |
| K | 49.116943 | −1.323357 | −99.000000 | −0.839308 |
| A4 | −6.289009.E−03 | −4.721032.E−03 | 3.230412.E−04 | 2.159646.E−04 |
| A6 | 1.139928.E−04 | 1.802105.E−04 | 2.506510.E−05 | −2.219206.E−05 |
| A8 | −2.112311.E−05 | −3.868783.E−05 | −1.149355.E−05 | 4.711632.E−06 |
| A10 | −6.625973.E−06 | −9.335107.E−06 | −4.084561.E−06 | −3.603485.E−06 |
| A12 | 2.734531.E−06 | 4.609325.E−06 | 2.969958.E−07 | 1.869900.E−07 |
| A14 | −5.341089E−07 | −8.895348E−07 | 0 | 0 |
| A16 | 6.138743E−08 | 1.001550E−07 | 0 | 0 |
| A18 | −3.616494E−09 | −6.118523E−09 | 0 | 0 |
| A20 | 8.383756E−11 | 1.555989E−10 | 0 | 0 |
| Si | 16(1ST SURFACE OF L6) | 17(2ND SURFACE OF L6) | 18(1ST SURFACE OF L7) | 19(2ND SURFACE OF L7) |
| K | −12.718705 | −17.116759 | −41.494114 | −13.200910 |
| A4 | −5.168652.E−03 | −1.304128.E−02 | −3.152907.E−02 | −1.713652.E−02 |
| A6 | 2.357814.E−03 | 5.951768.E−03 | 6.802235.E−03 | 2.306468.E−03 |
| A8 | −6.238836.E−04 | −1.894054.E−03 | −1.882185.E−03 | −2.686762.E−04 |
| A10 | 1.106074.E−04 | 3.950690.E−04 | 4.076420.E−04 | 3.051346.E−05 |
| A12 | −9.731140.E−06 | −4.892418.E−05 | −5.297349.E−05 | −2.586682.E−06 |
| A14 | −1.596999E−07 | 3.022523E−06 | 3.327238.E−06 | 9.586092.E−08 |
| A16 | 1.190562E−07 | −1.450278E−08 | −1.408962.E−09 | 4.100615.E−09 |
| A18 | −1.003179E−08 | −8.394057E−09 | −1.103287.E−08 | −5.045067.E−10 |
| A20 | 2.857810E−10 | 3.214122E−10 | 4.109262.E−10 | 1.295211.E−11 |

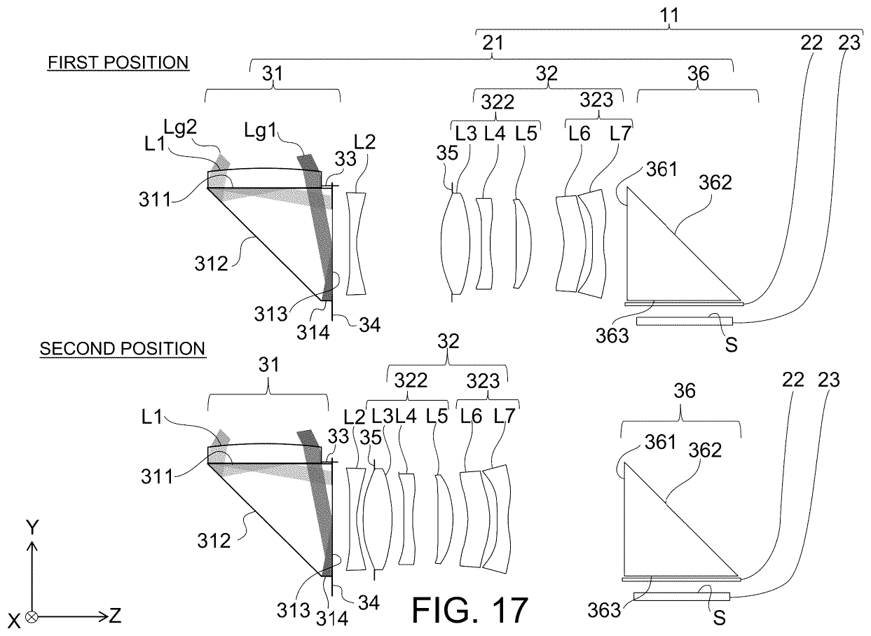

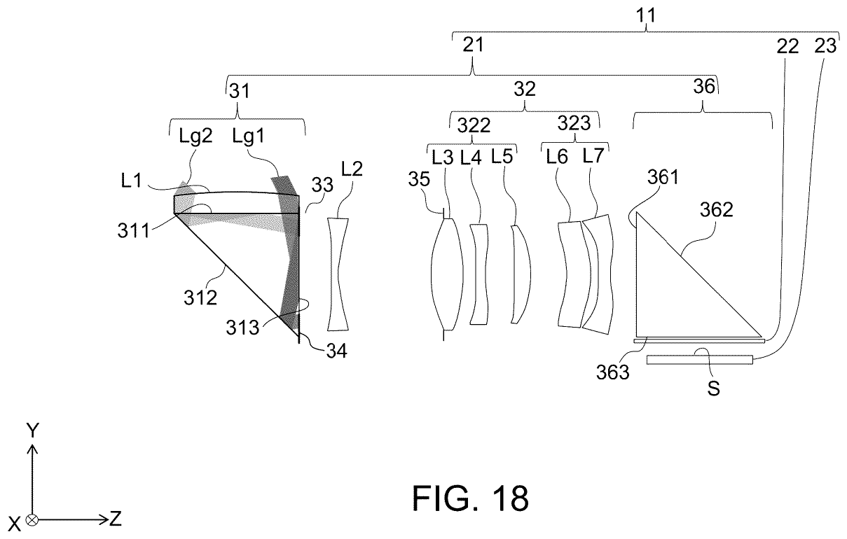

FIG. 17 shows the shielding of ghost rays in the imaging lens assembly 21 according to the third example. FIG. 18 shows the shielding of ghost rays in the imaging lens assembly 21 according to a third comparison example.

In the third example, the aperture diameter of the aperture stop 35 can be decreased by disposing the first lens L1 having positive refractive power on the object side of the prism 31. By decreasing the aperture diameter of the aperture stop 35, a volume occupied by the imaging lens assembly 21 in the housing 4 can be reduced, thereby effectively securing space to dispose electrical components or the like in the housing 4.

Further, since the aperture diameter of the aperture 35 can be decreased, the diameter of the central ray Lfno can also be decreased. Therefore, since there is a room for the diameter of the ray that passes through the prism 31, “D_W_FNO” does not become larger than “D_FNO” even in the second position as in the second example, and is the same as the F number D_FNO in both the first and second positions.

Further, in the third example, since the prism size (P_W_U) is expanded in the Z-axis direction by the plane part 314 provided on the prism 31, as shown in FIG. 17, it is possible to control the position, where the ghost ray Lg1 incident on one end of the incident surface 311 on the lens group 32 side is totally reflected by the emitting surface 313, to the lower end side of the emitting surface 313 as much as possible. As a result, in the third example, similar to that of the first example, the ghost rays Lg1, Lg2 may be effectively shielded by using the second light-shielding mask 34 (see FIG. 2A) having the vertically asymmetric shape where the light-shielding amount in the lower end of the emitting surface 313 is small. Further, according to the third example, the increase in the F number may be suppressed by using the second light-shielding mask 34 having the vertically asymmetric shape where the light-shielding amount in the lower end of the emitting surface 313 is small. Specifically, when the second lens group 322 and the third lens group 323 are positioned in the first position, the F number R_FNO can be set to 2.444 by setting the cross-sectional area of the central ray Lfno on the emitting surface 313 of the prism 31 to 34.871 mm². Further, when the second lens group 322 and the third lens group 323 are positioned in the second position, the F number R_FNO can be set to 3.523 by setting the cross-sectional area of the central ray Lfno on the emitting surface 313 of the prism 31 to 40.918 mm².

On the other hand, in the third comparison example, the prism size (P_W_U) is not expanded in the Z-axis direction since the prism height PH and the size PW of the prism 31 in the Z-axis direction are both 7.8 mm and the plane part 314 is not provided on the prism 31. Thus, as shown in FIG. 18, the ghost ray Lg1, which is incident on one end of the incident surface 311 on the lens group 32 side, is totally reflected at a high position on the emitting surface 313. Accordingly, in the third comparison example, the ghost rays Lg1, Lg2 cannot be effectively shielded without using the second light-shielding mask 34 (see the dot-dot dashed line in FIG. 2A) having the vertically symmetric shape. Accordingly, in the third comparison example, the size AD2 of the second aperture 341 of the second light-shielding mask 34 may be smaller than the size AD2 in the third example in order to shield the ghost ray Lg1. As a result, in the third example, the F number increases in order to reduce the ghost. Specifically, when the second lens group 322 and the third lens group 323 are positioned in the first position, the cross-sectional area of the central ray Lfno on the emitting surface 313 of the prism 31 becomes 23.981 mm² and the F number N_C_FNO becomes 2.461. When the second lens group 322 and the third lens group 323 are positioned in the second position, the cross-sectional area of the central ray Lfno on the emitting surface 313 of the prism 31 becomes 30.128 mm² and the F number N C FNO becomes 3.656.

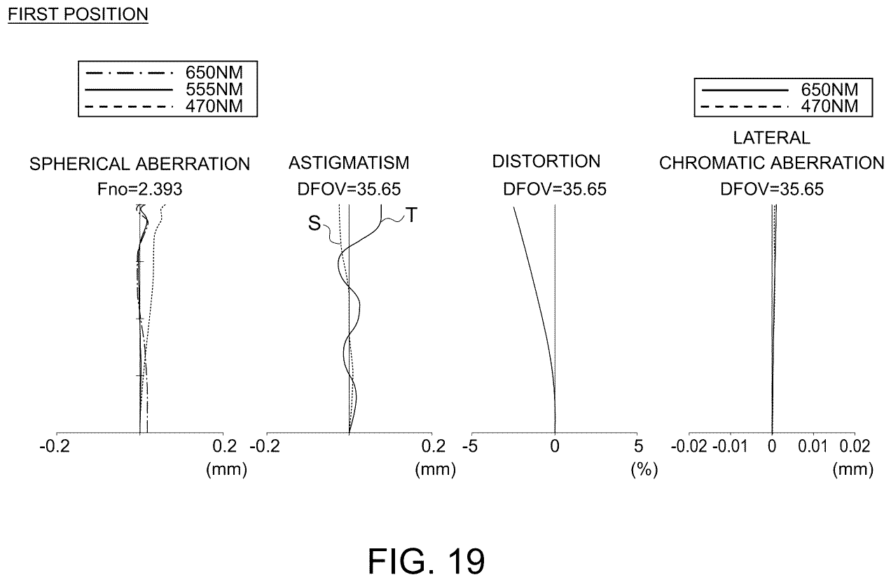

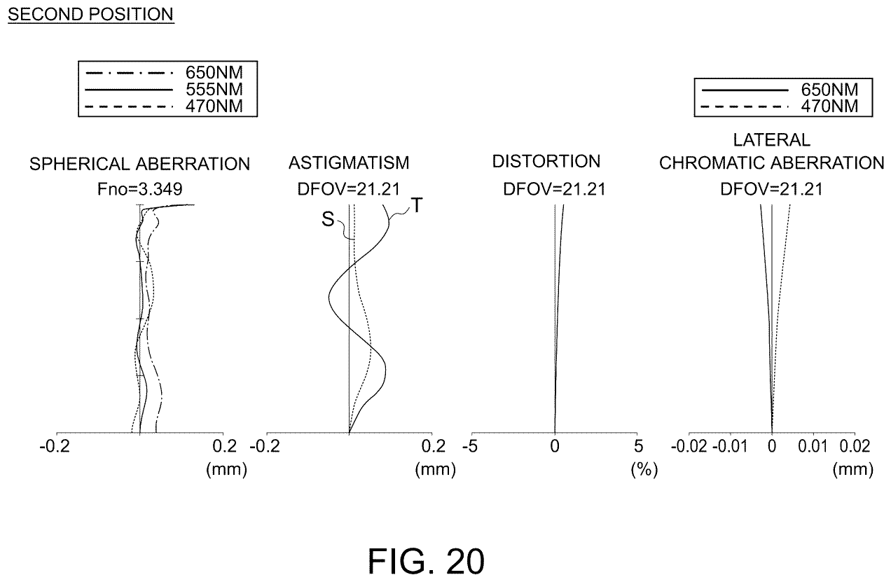

Aberrations in the third example are shown in FIGS. 19 and 20. According to the imaging lens assembly 21 of the third example, by differentiating the lens parameters from those of the first example, the degree of freedom in designing the camera module 11 may be further increased while obtaining the same effects as in the first example.

### Fourth Example

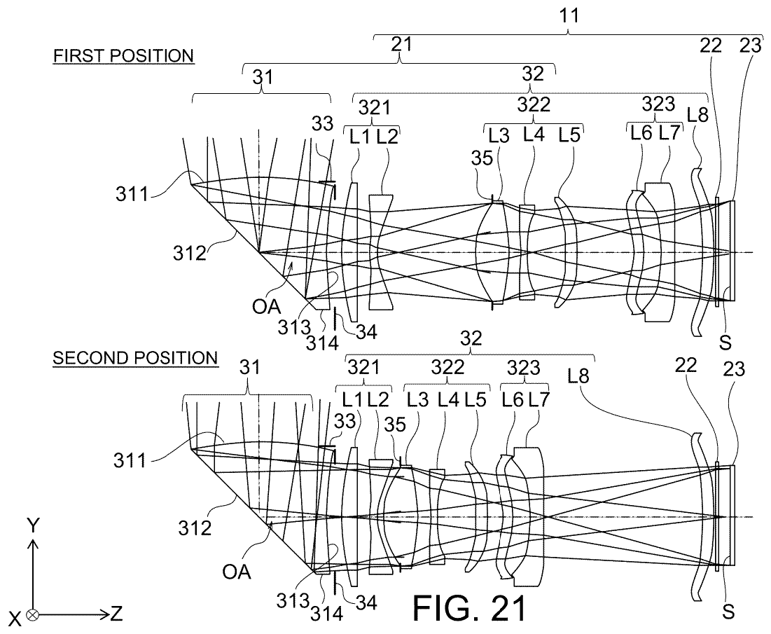

Next, a fourth example in which specific numeral values are applied to the camera module 11 shown in FIG. 21 will be described.

As shown in FIG. 21, the imaging lens assembly 21 according to the fourth example is similar to that of the second example in including the first lens group 321, the second lens group 322, and the third lens group 323.

On the other hand, the imaging lens assembly 21 according to the fourth example differs from that of the second example regarding the shape of the prism 31 and the number of the lens.

Specifically, as shown in FIG. 21, the incident surface 311 of the prism 31 in the fourth example is formed as a curved surface. More specifically, the incident surface 311 of the prism 31 is formed as a convex surface facing the object side.

In the fourth example, the prism 31 is formed of plastic.

Further, in the fourth example, the emitting surface 313 of the prism is formed as the curved surface. More specifically, the emitting surface 313 of the prism 31 is formed as a concave surface facing the image side. Since the concave surface of the incident surface 311 bends the rays, the aperture diameter of the aperture stop 35 may be decreased similar to that of the third example. By decreasing the aperture diameter of the aperture stop 35, the volume occupied by the imaging lens assembly 21 in the housing 4 can be reduced, thereby effectively securing space to dispose electrical components or the like in the housing 4.

Further, since the aperture diameter of the aperture 35 can be decreased, the diameter of the central ray Lfno can also be decreased. Thus, since there is room for the diameter of the ray that passes through the prism 31, “D_W_FNO” is the same as the F number D FNO in both the first and second positions, as in the third example.

Further, the prism 31 is formed lightweight by plastic, and the refractive power of the prism 31 itself is decreased by the fact that the emitting surface 313 of the prism 31 is formed concave. This makes it possible to perform optical image stabilization properly even when the prism 31 is tilted. Thus, there is no need for the OIS that shifts a portion of the lens group or the sensor as in the third example. Also, forming the prism 31 of plastic makes no need to secure an edge during lens manufacturing as in the first lens L1 in the third example, which allows shortening the height of the prism 31.

Further, the imaging lens assembly 21 in the fourth example includes an eighth lens L8 disposed on the image side of the third lens group 323. The eighth lens L8 is a lens in which the position is fixed in the optical axis OA direction.

The lens parameters corresponding to those in the first to the third examples are as shown in Tables 12-15.

TABLE 12

| | | | | | FOCAL | COMPOSITE |
|---|---|---|---|---|---|---|
| Si | Ri | Di | Ndi | Vdi | LENGTH | FOCAL LENGTH |
| 1 (OBJECT) | INF | INF | | | | |
| 2(INCIDENT SURFACE | 25.134 | [symbol] .300 | 1.544 | 56.332 | 117.75 | ZOOM |
| OF PRISM) | | | | | | |
| 3(REFLECTIVE SURFACE | INF | 4. [symbol] 00 | 1.544 | [symbol] 6.332 | | |
| OF PRISM) | | | | | | |
| 4(EMITTING SURFACE | 38. [symbol] 88 | [symbol] .000 | | | | |
| OF PRISM) | | | | | | |
| 5(1ST SURFACE OF L1) | [symbol] 8.302 | [symbol] 50 | 1.717 | 35.950 | 26.75 | |
| 6(2ND SURFACE OF L1) | 348. [symbol] 99 | 0. [symbol] 2 | | | | |
| 7(1ST SURFACE OF L2) | 7. [symbol] 76 | 0.498 | 1. [symbol] 44 | 56.332 | −11. [symbol] 5 | |
| 8(2ND SURFACE OF L2) | 3.425 | ZOOM | | | | |
| 9 | INF | [symbol] .332 | | | | |
| 10(APERTURE STOP) | INF | −2.282 | | | | |
| 11(1ST SURFACE OF L3) | 8. [symbol] 6 | 2. [symbol] | 2.497 | [symbol] .3 [symbol] 0 | 7.55 | |
| 12(2ND SURFACE OF L3) | − [symbol] 0.861 | 0.806 | | | | |
| 13(1ST SURFACE OF L4) | −39.18 [symbol] | 0.461 | 1.5 [symbol] | 21.04 [symbol] | −1 [symbol] | |
| 14(2ND SURFACE OF L4) | 10.614 | 2.891 | | | | |
| 15(1ST SURFACE OF L5) | −32.5 [symbol] 0 | 0. [symbol] 80 | 1.671 | 19.230 | 20.95 | |
| 16(2ND SURFACE OF L5) | −9. [symbol] 85 | ZOOM | | | | |
| 17(1ST SURFACE OF L6) | −5.922 | 0.737 | 2. [symbol] 71 | 19.230 | 152.81 | |
| 18(2ND SURFACE OF L6) | −5.90 [symbol] | 1.234 | | | | |
| 19(1ST SURFACE OF L7) | 79.400 | 0. [symbol] | 1.544 | 55.332 | −13.53 | |
| 20(2ND SURFACE OF L7) | [symbol] .739 | ZOOM | | | | |
| 21(1ST SURFACE OF L8) | − [symbol] 345. [symbol] 35 | 0.782 | 2.67 [symbol] | 19.230 | −49.34 | |
| 22(2ND SURFACE OF L8) | 84.260 | 0. [symbol] 00 | | | | |
| 23(1ST SURFACE OF | INF | 0. [symbol] 20 | 2.817 | 84.167 | | |
| COLOR CORRECTION FILTER) | | | | | | |
| 24(2ND SURFACE OF | INF | 0.7 [symbol] 0 | | | | |
| COLOR CORRECTION FILTER) | | | | | | |
| 25(IMAGING PLANE) | INF | 0.000 | | | | |
| 26 | INF | 0.000 | | | | |
| 27 | INF | 0.000 | | | | |

[symbol]

indicates data missing or illegible when filed

TABLE 13

| | FIRST | SECOND |
|---|---|---|
| ZOOM | POSITION | POSITION |
| 8(2ND SURFACE OF L2) | 6.710 | 0.500 |
| 16(2ND SURFACE OF L5) | 3.782 | 1.035 |
| 20(2ND SURFACE OF L7) | 2.000 | 10.957 |
| COMPOSITE FOCAL LENGTH | 18.527 | 34.867 |

TABLE 14

| | |
|---|---|
| FIRST POSITION | SECOND POSITION |

| | |
|---|---|
| S_d | 5.720 |
| S_s | 3.432 |

| | | |
|---|---|---|
| EFL | 18.527 | 34.867 |
| D_FNO | 2.600 | 4.128 |
| D_W_FNO | 2.600 | 4.128 |
| R_FNO | 2.600 | 4.130 |
| N_C_FNO | 2.613 | 4.246 |
| DFOV | 35.14 | 18.73 |

| | |
|---|---|
| LAH | 6.80 |
| PH | 8.59 |
| PW | 9.61 |
| P_in_L | 4.68 |
| P_in_R | 4.93 |
| AD1 | 9.20 |
| AD2 | 7.27 |
| AD2_u | 3.60 |
| P_W_U | 0.97 |

| | | |
|---|---|---|
| TAN(DFOV/2) | 0.32 | 0.16 |
| EFL/S_d | 3.24 | 6.10 |

TABLE 15

| | 2(INCIDENT SURFACE | 4(EMITTING SURFACE | | |
|---|---|---|---|---|
| Si | OF PRISM) | OF PRISM) | 7(1ST SURFACE OF L2) | 8(2ND SURFACE OF L2) |
| K | 1.385847 | −1.994105 | −5.790217 | −4.008226 |
| A4 | −8.288139.E−06 | 9.274614.E−05 | −1.447330.E−02 | −8.571433.E−03 |
| A6 | −7.050779.E−07 | −1.979854.E−06 | 2.275999.E−03 | 1.696200.E−03 |
| A8 | 1.423928.E−08 | −8.065742.E−08 | −2.581191.E−04 | −1.871147.E−04 |
| A10 | −1.704167.E−10 | 4.236927.E−09 | 1.954766.E−05 | 6.290055.E−06 |
| A12 | 6.753650.E−14 | −1.794959.E−10 | −7.825902.E−07 | 1.514286.E−06 |
| A14 | 2.414260.E−14 | 1.120615.E−11 | −4.969679.E−09 | −2.711521.E−07 |
| A16 | −6.217631.E−17 | −2.093882.E−13 | 2.196005.E−09 | 2.094133.E−08 |
| A18 | −2.407243.E−18 | −2.568921.E−15 | −9.672766.E−11 | −8.247124.E−10 |
| A20 | 1.710529.E−20 | 9.693191.E−17 | 1.466669.E−12 | 1.343512.E−11 |

| Si | 11(1ST SURFACE OF L3) | 12(2ND SURFACE OF L3) | 13(1ST SURFACE OF L4) | 14(2ND SURFACE OF L4) |
|---|---|---|---|---|
| K | −0.925438 | −10.170919 | 35.884846 | 5.621826 |
| A4 | 4.578589.E−04 | 3.262817.E−04 | −1.716178.E−04 | −1.100339.E−03 |
| A6 | 1.009594.E−05 | −4.385166.E−05 | 1.375413.E−04 | 2.079448.E−04 |
| A8 | −2.177679.E−06 | 4.239363.E−07 | −1.637102.E−05 | −1.180552.E−05 |
| A10 | 1.743641.E−07 | 1.700249.E−08 | −1.063468.E−06 | −3.934618.E−06 |
| A12 | −1.411444.E−08 | −2.259975.E−09 | 8.228838.E−07 | 1.453551.E−06 |
| A14 | 0 | 0 | −1.275969.E−07 | −2.050966.E−07 |
| A16 | 0 | 0 | 1.120257.E−08 | 1.808862.E−08 |
| A18 | 0 | 0 | −5.463882.E−10 | −9.611066.E−10 |
| A20 | 0 | 0 | 1.136046.E−11 | 2.729527.E−11 |
| Si | 15(1ST SURFACE OF L5) | 16(2ND SURFACE OF L5) | 17(1ST SURFACE OF L6) | 18(2ND SURFACE OF L6) |
| K | 83.358563 | 2.790820 | −17.379909 | −15.215201 |
| A4 | −1.717583.E−03 | −1.174309.E−03 | −6.994069.E−03 | −9.174791.E−03 |
| A6 | −1.527796.E−04 | −5.534069.E−05 | 2.417700.E−03 | 2.754719.E−03 |
| A8 | 3.745690.E−05 | −1.143539.E−05 | −5.137485.E−04 | −5.664170.E−04 |
| A10 | −1.528160.E−05 | 1.154981.E−06 | 8.827075.E−05 | 9.729940.E−05 |
| A12 | 3.361172.E−06 | 3.063347.E−08 | −1.045251.E−05 | −1.182433.E−05 |
| A14 | −4.701591.E−07 | −3.603198.E−08 | 8.010995.E−07 | 9.722485.E−07 |
| A16 | 4.031557.E−08 | 4.926630.E−09 | −3.795358.E−08 | −5.263051.E−08 |
| A18 | −1.864167.E−09 | −2.713392.E−10 | 1.023545.E−09 | 1.720958.E−09 |
| A20 | 3.657949.E−11 | 5.625571.E−12 | −1.225400.E−11 | −2.552753.E−11 |
| Si | 19(1ST SURFACE OF L7) | 20(2ND SURFACE OF L7) | 21(1ST SURFACE OF L8) | 22(2ND SURFACE OF L8) |
| K | −99.000000 | −30.190508 | −99.000000 | 25.649530 |
| A4 | −2.382639.E−02 | −9.973264.E−03 | −1.465718.E−02 | −2.639751.E−02 |
| A6 | 4.600382.E−03 | 1.475709.E−03 | 4.250143.E−03 | 6.826085.E−03 |
| A8 | −8.153274.E−04 | −1.366836.E−04 | −6.820529.E−04 | −9.797022.E−04 |
| A10 | 1.342614.E−04 | 8.661622.E−06 | 6.476420.E−05 | 8.421441.E−05 |
| A12 | −1.749252.E−05 | −4.248876.E−07 | −3.844123.E−06 | −4.564388.E−06 |
| A14 | 1.571199.E−06 | 1.686041.E−08 | 1.441145.E−07 | 1.575184.E−07 |
| A16 | −8.952727.E−08 | −5.248753.E−10 | −3.308012.E−09 | −3.361942.E−09 |
| A18 | 2.879925.E−09 | 1.106434.E−11 | 4.241582.E−11 | 4.061947.E−11 |
| A20 | −3.922588.E−11 | −1.093442.E−13 | −2.328001.E−13 | −2.137041.E−13 |

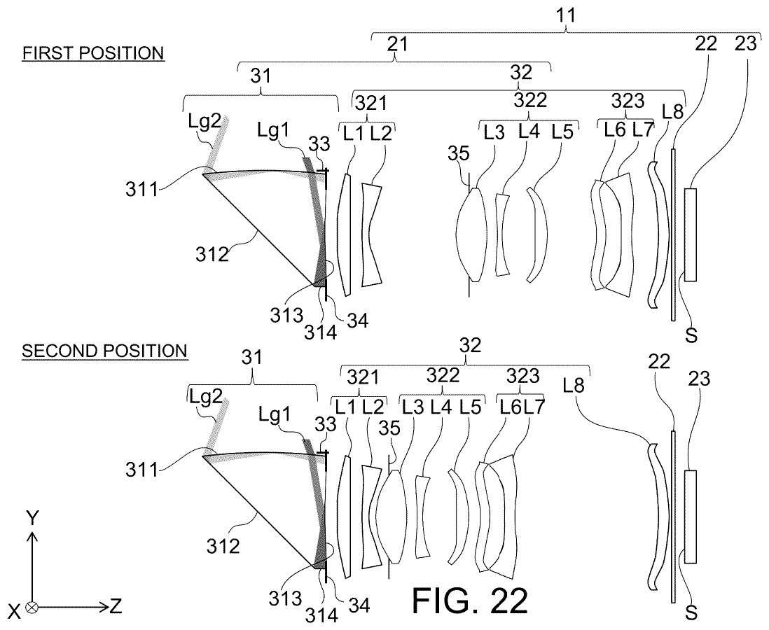

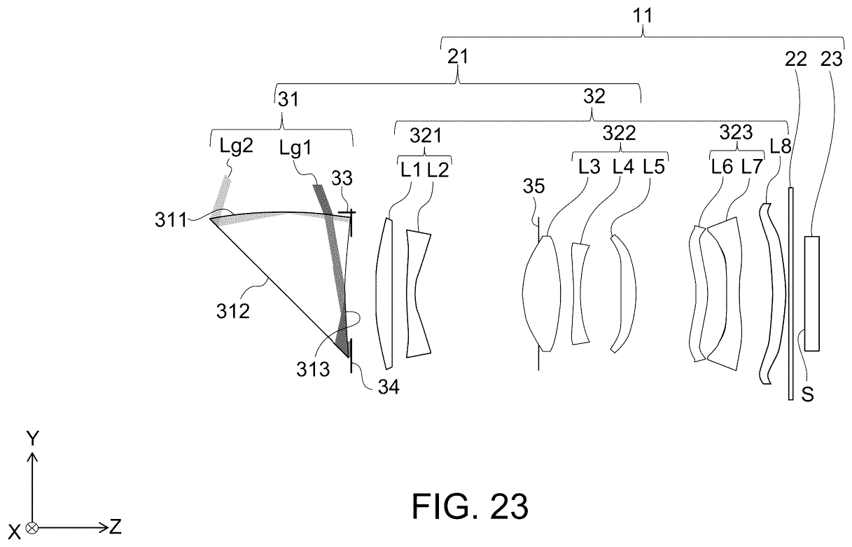

FIG. 22 shows the shielding of ghost rays in the imaging lens assembly 21 in the fourth example. FIG. 23 shows the shielding of ghost rays in the imaging lens assembly 21 in a fourth comparison example.

In the fourth example, unlike those in the first to the third examples, the incident surface 311 of the prism 31 is a convex surface facing the object side, so that a position, where the ghost ray Lg2 totally reflected by the incident surface 311 reaches the emitting surface 313, can be controlled to the upper end side of the emitting surface 313 as much as possible. By such, the ghost rays Lg1, Lg2 can be effectively shielded by using the second light-shielding mask 34 where not only the light-shielding amount in the lower end but also the upper end of the emitting surface 313 are small. Further, according to the fourth example, the increase in the F number can be suppressed by using the second light-shielding mask 34 where the light-shielding amount in the lower end and the upper end of the emitting surface 313 is small. Specifically, when the second lens group 322 and the third lens group 323 are positioned in the first position, the F number R_FNO can be set to 2.600 by setting the cross-sectional area of the central ray Lfno on the emitting surface 313 of the prism 31 to 30.145 mm². Further, when the second lens group 322 and the third lens group 323 are positioned in the second position, the F number R_FNO can be set to 4.130, which is almost equal to the D_FNO, by setting the cross-sectional area of the central ray Lfno on the emitting surface 313 of the prism 31 to 42.067 mm².

On the other hand, in the fourth comparison example, the prism size (P_W_U) is not expanded in the Z-axis direction since the prism height PH and the size PW of the prism 31 in the Z-axis direction are both 8.72 mm. Thus, as shown in FIG. 23, the ghost ray Lg1, which is incident on one end of the incident surface 311 on the lens group 32 side, is totally reflected on a relatively high position of the emitting surface 313. Accordingly, in the fourth comparison example, the ghost rays Lg1, Lg2 cannot be effectively shielded without using the second light-shielding mask 34 (see the dot-dot dashed line in FIG. 2A) having the vertically symmetric shape. Therefore, in the fourth comparison example, the size AD2 of the second aperture 341 of the second light-shielding mask 34 may be smaller than the size AD2 in the fourth example in order to shield the ghost ray Lg1. As a result, in the fourth example, the F number increases in order to reduce the ghost. Specifically, when the second lens group 322 and the third lens group 323 are positioned in the first position, the cross-sectional area of the central ray Lfno on the emitting surface 313 of the prism 31 becomes 29.856 mm² and the F number N_C_FNO becomes 2.613. When the second lens group 322 and the third lens group 323 are positioned in the second position, the cross-sectional area of the central ray Lfno on the emitting surface 313 of the prism 31 becomes 39.800 mm² and the F number N_C_FNO becomes 4.246.

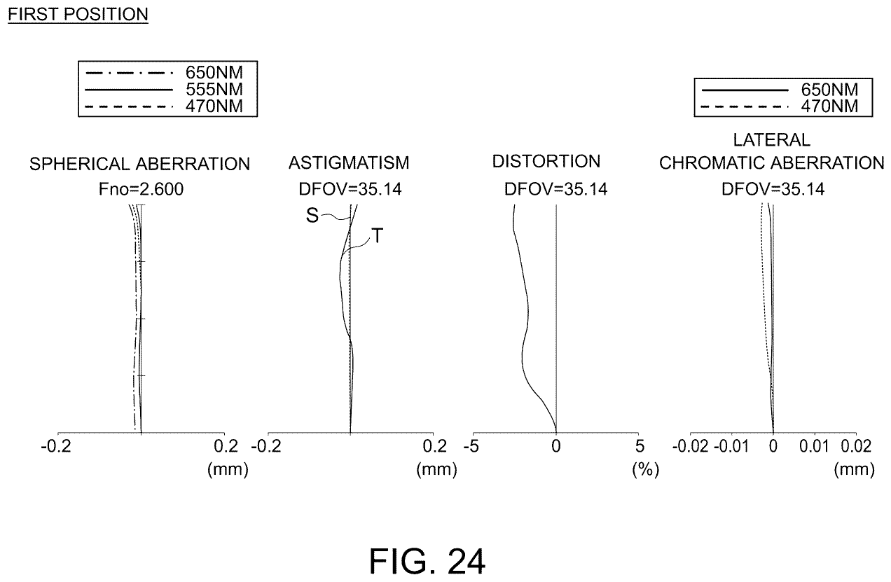

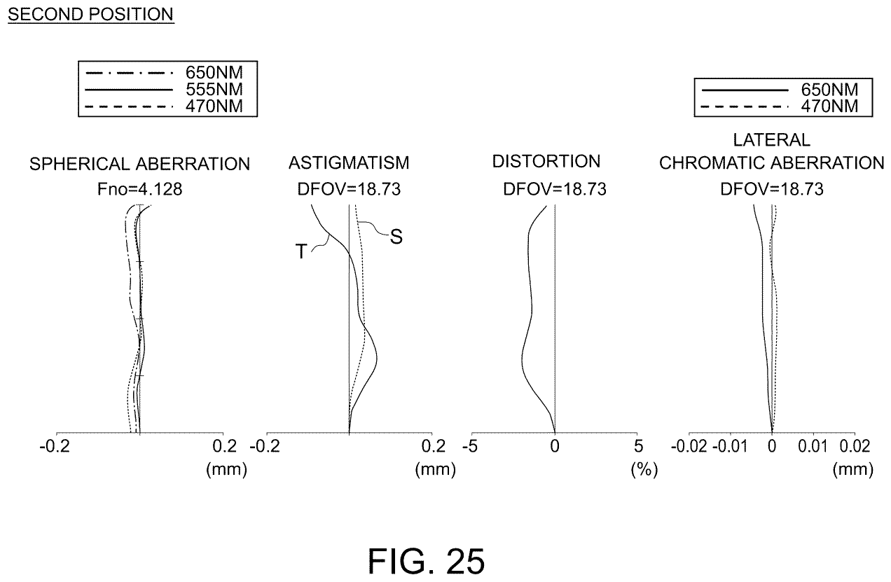

Aberrations in the fourth example are shown in FIGS. 24 and 25. According to the imaging lens assembly of the fourth example, by differentiating the lens parameters from those of the first to the third example, the freedom in designing the camera module 11 may be further increased while obtaining the same effects as in the first example.

In the description of embodiments of the present disclosure, it is to be understood that terms such as “central”, “longitudinal”, “transverse”, “length”, “width”, “thickness”, “upper”, “lower”, “front”, “rear”, “left”, “right”, “vertical”, “horizontal”, “top”, “bottom”, “inner”, “outer”, “clockwise” and “counterclockwise” should be construed to refer to the orientation or the position as described or as shown in the drawings under discussion. These relative terms are only used to simplify description of the present disclosure, and do not indicate or imply that the device or element referred to must have a particular orientation, or constructed or operated in a particular orientation. Thus, these terms cannot be constructed to limit the present disclosure.

In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present disclosure, “a plurality of” means two or more than two, unless specified otherwise.

In the description of embodiments of the present disclosure, unless specified or limited otherwise, the terms “mounted”, “connected”, “coupled” and the like are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

In the embodiments of the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on”, “above” or “on top of” a second feature may include an embodiment in which the first feature is right or obliquely “on”, “above” or “on top of” the second feature, or just means that the first feature is at a height higher than that of the second feature; while a first feature “below”, “under” or “on bottom of” a second feature may include an embodiment in which the first feature is right or obliquely “below”, “under” or “on bottom of” the second feature, or just means that the first feature is at a height lower than that of the second feature.

Various embodiments and examples are provided in the above description to implement different structures of the present disclosure. In order to simplify the present disclosure, certain elements and settings are described in the above. However, these elements and settings are only by way of example and are not intended to limit the present disclosure. In addition, reference numbers and/or reference letters may be repeated in different examples in the present disclosure. This repetition is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

Reference throughout this specification to “an embodiment”, “some embodiments”, “an exemplary embodiment”, “an example”, “a specific example” or “some examples” means that a particular feature, structure, material, or characteristic described in connection with the embodiment or example is included in at least one embodiment or example of the present disclosure. Thus, the appearances of the above phrases throughout this specification are not necessarily referring to the same embodiment or example of the present disclosure. Furthermore, the particular features, structures, materials, or characteristics may be combined in any suitable manner in one or more embodiments or examples.

Any process or method described in a flow chart or described herein in other ways may be understood to include one or more modules, segments or portions of codes of executable instructions for achieving specific logical functions or steps in the process, and the scope of a preferred embodiment of the present disclosure includes other implementations, in which it should be understood by those skilled in the art that functions may be implemented in a sequence other than the sequences shown or discussed, including in a substantially identical sequence or in an opposite sequence.

The logic and/or step described in other manners herein or shown in the flow chart, for example, a particular sequence table of executable instructions for realizing the logical function, may be specifically achieved in any computer readable medium to be used by the instruction execution system, device or equipment (such as the system based on computers, the system comprising processors or other systems capable of obtaining the instruction from the instruction execution system, device and equipment and executing the instruction), or to be used in combination with the instruction execution system, device and equipment. As to the specification, “the computer readable medium” may be any device adaptive for including, storing, communicating, propagating or transferring programs to be used by or in combination with the instruction execution system, device or equipment. More specific examples of the computer readable medium comprise but are not limited to: an electronic connection (an electronic device) with one or more wires, a portable computer enclosure (a magnetic device), a random access memory (RAM), a read only memory (ROM), an erasable programmable read-only memory (EPROM or a flash memory), an optical fiber device and a portable compact disk read-only memory (CDROM). In addition, the computer readable medium may even be a paper or other appropriate medium capable of printing programs thereon, this is because, for example, the paper or other appropriate medium may be optically scanned and then edited, decrypted or processed with other appropriate methods when necessary to obtain the programs in an electric manner, and then the programs may be stored in the computer memories.

It should be understood that each part of the present disclosure may be realized by the hardware, software, firmware or their combination. In the above embodiments, a plurality of steps or methods may be realized by the software or firmware stored in the memory and executed by the appropriate instruction execution system. For example, if it is realized by the hardware, likewise in another embodiment, the steps or methods may be realized by one or a combination of the following techniques known in the art: a discrete logic circuit having a logic gate circuit for realizing a logic function of a data signal, an application-specific integrated circuit having an appropriate combination logic gate circuit, a programmable gate array (PGA), a field programmable gate array (FPGA), etc.

Those skilled in the art shall understand that all or parts of the steps in the above exemplifying method of the present disclosure may be achieved by commanding the related hardware with programs. The programs may be stored in a computer readable storage medium, and the programs comprise one or a combination of the steps in the method embodiments of the present disclosure when run on a computer.

In addition, each function cell of the embodiments of the present disclosure may be integrated in a processing module, or these cells may be separate physical existence, or two or more cells are integrated in a processing module. The integrated module may be realized in a form of hardware or in a form of software function modules. When the integrated module is realized in a form of software function module and is sold or used as a standalone product, the integrated module may be stored in a computer readable storage medium.

The storage medium mentioned above may be read-only memories, magnetic disks, CD, etc.

Although embodiments of the present disclosure have been shown and described, it would be appreciated by those skilled in the art that the embodiments are explanatory and cannot be construed to limit the present disclosure, and changes, modifications, alternatives and variations can be made in the embodiments without departing from the scope of the present disclosure.

1. An imaging lens assembly, comprising:
an optical axis direction changing element that changes an optical axis direction, wherein the optical axis direction changing element comprises an incident surface disposed on a first optical axis having a first optical axis direction before being changed and an emitting surface disposed on a second optical axis having a second optical axis direction after being changed; and
a lens group disposed on the second optical axis on an image side of the optical axis direction changing element and comprising at least one lens,
wherein the imaging lens assembly is configured such that:
$$P\_in \_L < P\_in \_R ,$$
where P_in_L is a distance from the first optical axis to one end of the incident surface on an opposite side of the lens group, and P_in_R is a distance from the first optical axis to another end of the incident surface on the lens group side.

2. The imaging lens assembly according to claim 1, configured such that:
$$PW > PH ,$$
where PH is a dimension of the optical axis direction changing element in the first optical axis direction and PW is a dimension of the optical axis direction changing element in the second optical axis direction.

3. The imaging lens assembly according to claim 1, configured such that:
$$EFL / S\_d > 1.25 ,$$
where EFL is a focal length of the lens group and S_d is a diagonal image height of an image sensor to be disposed on the image side of the lens group.

4. The imaging lens assembly according to claim 1, further comprising:
a first light-shielding mask disposed on the incident surface and provided with a first aperture that partially transmits incident light from an object side; and
a second light-shielding mask disposed on the emitting surface and provided with a second aperture that partially transmits emitting light to the image side,
wherein the imaging lens assembly is configured such that:
$$AD 1 \geq AD 2 ,$$
where AD1 is a size of the first aperture in the second optical axis direction and AD2 is a size of the second aperture in the first optical axis direction.

5. The imaging lens assembly according to claim 1, wherein the optical axis direction changing element further comprises an optical axis direction changing surface disposed on the first optical axis and the second optical axis between the incident surface and the emitting surface,
wherein the imaging lens assembly is configured such that:
$$P\_W \_U > 0.4 mm ,$$
where P_W_U is a distance in the second optical axis direction between one end of the optical axis direction changing surface on an opposite side of the incident surface and one end of the emitting surface on an opposite side of the incident surface.

6. The imaging lens assembly according to claim 5, wherein the one end of the optical axis direction changing surface on the opposite side of the incident surface and the one end of the emitting surface on the opposite side of the incident surface are connected by a plane part.

7. The imaging lens assembly according to claim 1, further comprising:
a first light-shielding mask disposed on the incident surface and provided with a first aperture that partially transmits incident light from an object side;
a second light-shielding mask disposed on the emitting surface and provided with a second aperture that partially transmits emitting light to the image side; and
an aperture stop provided in the lens group,
wherein the imaging lens assembly is configured such that:
$$LAH \leq AD 1 ,$$
where LAH is an aperture diameter of the aperture stop in the first optical axis direction and AD1 is a size of the first aperture in the second optical axis direction.

8. The imaging lens assembly according to claim 1, configured such that:
$$tan ( DFOV / 2 ) < 0.61 ,$$
where DFOV is a field of view of the lens group.

9. The imaging lens assembly according to claim 1, further comprising:
a first light-shielding mask disposed on the incident surface and provided with a first aperture that partially transmits incident light from an object side; and
a second light-shielding mask disposed on the emitting surface and provided with a second aperture that partially transmits emitting light to the image side,
wherein the second aperture has a circular shape where both ends in the first optical axis direction are missing.

10. The imaging lens assembly according to claim 9, wherein the second aperture has an asymmetric shape with respect to a straight line perpendicular to the first optical axis direction and the second optical axis direction, the straight line being defined on an intersection of the second aperture and the second optical axis.

11. The imaging lens assembly according to claim 1, wherein the at least one lens among the lens group is movable in a direction perpendicular to the second optical axis by an optical image stabilizer (OIS).

12. The imaging lens assembly according to claim 1, wherein the optical axis direction changing element is tiltable by a second optical image stabilizer (OIS).

13. The imaging lens assembly according to claim 1, wherein at least one of the incident surface and the emitting surface is a curved surface.

14. The imaging lens assembly according to claim 1, further comprising at least one lens disposed on an object side or the image side of the optical axis direction changing element, the at least one lens being formed of glass and having positive refractive power.

15. The imaging lens assembly according to claim 1, further comprising a second optical axis direction changing element that changes the optical axis direction, the second optical axis direction changing element being disposed on the image side of the lens group, comprising a second incident surface disposed on the second optical axis and a second emitting surface disposed on a third optical axis having the first optical axis direction.

16. A camera module, comprising:
an imaging lens assembly, comprising:
an optical axis direction changing element that changes an optical axis direction, wherein the optical axis direction changing element comprises an incident surface disposed on a first optical axis having a first optical axis direction before being changed and an emitting surface disposed on a second optical axis having a second optical axis direction after being changed; and
a lens group disposed on the second optical axis on an image side of the optical axis direction changing element and comprising at least one lens,
wherein the imaging lens assembly is configured such that:
$$P\_in \_L < P\_in \_R ,$$
where P_in_L is a distance from the first optical axis to one end of the incident surface on an opposite side of the lens group, and P_in_R is a distance from the first optical axis to another end of the incident surface on the lens group side; and
an image sensor disposed on the image side of the imaging lens assembly.

17. The camera module according to claim 16, further comprising:
an optical filter disposed between the imaging lens assembly and the image sensor.

18. The camera module according to claim 16, wherein the image sensor is movable in a direction along an imaging surface of the image sensor by a third optical image stabilizer (OIS).

19. An imaging device, comprising:
an imaging lens assembly, comprising:
an optical axis direction changing element that changes an optical axis direction, wherein the optical axis direction changing element comprises an incident surface disposed on a first optical axis having a first optical axis direction before being changed and an emitting surface disposed on a second optical axis having a second optical axis direction after being changed; and
a lens group disposed on the second optical axis on an image side of the optical axis direction changing element and comprising at least one lens,
wherein the imaging lens assembly is configured such that:
$$P\_in \_L < P\_in \_R ,$$
where P_in_L is a distance from the first optical axis to one end of the incident surface on an opposite side of the lens group, and P_in_R is a distance from the first optical axis to another end of the incident surface on the lens group side;
an image sensor disposed on the image side of the imaging lens assembly; and
a housing that stores the imaging lens assembly and the image sensor.

20. The imaging device according to claim 19, further comprising a lens driver that drives the at least one lens among the lens group in the second optical axis direction.
